(19) United States
(12) Patent Application Publication
(10) Pub. No.: US 2026/0030764 A1
(43) Pub. Date: Jan. 29, 2026

(54) RENDERED IMAGE DATA PROCESSING AND OPTICAL FLOW CALCULATION

(71) Applicant: Arm Limited, Cambridge (GB)

(72) Inventors: Joshua James SOWERBY, London (GB); Carlos BARRAGÁN DEL REY, Manchester (GB); Liam James O'NEIL, Manchester (GB); Yanxiang WANG, Cheshire (GB)

(21) Appl. No.: 18/783,935

(22) Filed: Jul. 25, 2024

(51) Int. Cl. G06T 7/223; G06T 7/246; G06T 7/50; G06T 7/60; G06T 7/73

(52) U.S. Cl. CPC G06T 7/223; G06T 7/248; G06T 7/50; G06T 7/60; G06T 7/73

(57) ABSTRACT

A processing system, computer-readable storage medium, and method for determining optical flow vector data for a rendered scene is provided. The method comprises obtaining motion vector data based on geometry data representing the rendered scene, obtaining template data derived from a first rendered frame, obtaining search data from a second rendered frame, and performing a block matching procedure using the template data, the search data, and the motion vector data. The optical flow vector data, comprising an optical flow vector corresponding to the template data, is determined and represents a spatial offset between the template data and an identified portion of search data.

### BACKGROUND OF THE INVENTION

### Field of the Invention

The present disclosure relates to computer-implemented processes for determining motion vector information in image processing.

### Description of the Related Technology

Rendered images are visual representations created by computer software through the process of rendering. This may involve converting 3D models or scenes into 2D images or animations, using various algorithms to simulate light, shadow, texture, and color.

Rendering is used in a variety of applications including video games and virtual reality. In real-time rendering applications rendering speed is often important to simulate realistic motion and movement in the rendered scene. Rendering may also be performed offline, that is not in real-time, such as when producing animated films, live-action films, visual effects, and product design. A number of techniques are used when rendering such as ray tracing, rasterization, and global illumination.

### SUMMARY

According to a first aspect of the present disclosure there is provided a processing system configured to determine optical flow vector data for a rendered scene using template data and search data, the processing system comprising circuitry configured to cause the processing system to: obtain motion vector data based on geometry data representing the rendered scene; obtain template data derived from a portion of a first frame of image data representing the rendered scene; obtain search data derived from a portion of a second frame of image data representing the rendered scene; perform a block matching procedure, using the template data, the motion vector data, and a set of offset positions to be applied to the search data, to identify a portion of the search data; and determine optical flow vector data comprising an optical flow vector corresponding to the template data representing a spatial offset between the template data and the identified portion of search data.

According to a second aspect of the present disclosure there is provided a computer implemented method for determining optical flow vector data for a rendered scene using template data and search data, the method comprising: obtaining motion vector data based on geometry data representing the rendered scene; obtaining template data derived from a portion of a first frame of image data representing the rendered scene; obtaining search data derived from a portion of a second frame of image data representing the rendered scene; performing a block matching procedure, using the template data, the motion vector data, and a set of offset positions to be applied to the search data, to identify a portion of the search data; and determining optical flow vector data comprising an optical flow vector corresponding to the template data representing a spatial offset between the template data and the identified portion of the search data.

According to third aspect of the present disclosure there is provided a non-transitory computer-readable storage medium comprising computer-executable instructions which, when executed by a processor, cause the processor to: obtain motion vector data based on geometry data representing the rendered scene; obtain template data derived from a portion of a first frame of image data representing the rendered scene; obtain search data derived from a portion of a second frame of image data representing the rendered scene; perform a block matching procedure, using the template data, the motion vector data, and a set of offset positions to be applied to the search data, to identify a portion of the search data; and determine optical flow vector data comprising an optical flow vector corresponding to the template data representing a spatial offset between the template data and the identified portion of the search data.

According to a fourth aspect of the present disclosure there is provided a processing system for processing template data and search data according to a search window applied to the search data, the search window comprising a set of offset positions, the processing system comprising a rendering engine, an execution engine, and a motion engine, the rendering engine being configured to generate motion vector data based on geometry data representing a rendered scene, the execution engine being configured to: obtain template data derived from a portion of a first frame of image data representing the rendered scene; obtain search data derived from a portion of a second frame of image data representing the rendered scene; determine the set of offset positions using the motion vector data; and determine search window data representing the set of offset positions applied to the search data by, for each offset position, selecting a corresponding portion of the search data, and the motion engine being configured to: determine, for each offset position, a measure of similarity between the template data and the corresponding portion of the search data; and determine optical flow vector data comprising an optical flow vector corresponding to the template data by selecting an offset position of the set of offset positions based on the measures of similarity between the template data and the corresponding portions of the search data.

According to a fifth aspect of the present disclosure there is provided a processing system for processing template data and search data according to a search window applied to the search data, the search window comprising a set of offset positions, the processing system comprising, a rendering engine, an execution engine, and a motion engine, the rendering engine being configured to generate motion vector data based on geometry data representing a rendered scene, the execution engine being configured to: obtain template data derived from a portion of a first frame of image data representing the rendered scene; obtain search data derived from a portion of a second frame of image data representing the rendered scene; and determine search window data by: for each offset position, selecting a corresponding portion of the search data; and selecting a further portion of the search data based on the motion vector data, and the motion engine being configured to: determine, for each offset position, a measure of similarity between the template data and the corresponding portion of the search data; determine a measure of similarity between the template data and the further portion of the search data; and determine optical flow vector data comprising an optical flow vector corresponding to the template data by selecting either: an offset position of the set of offset positions; or the motion vector data, wherein the selecting is dependent on the measures of similarity.

According to a sixth aspect of the present disclosure there is provided a computer implemented method for determining an optical flow vector for a rendered scene using template data and search data, the method comprising: generating motion vector data based on geometry data representing a rendered scene; obtaining template data derived from a portion of a first frame of image data representing the rendered scene; obtaining search data derived from a portion of a second frame of image data representing the rendered scene; determining the set of offset positions using the motion vector data; and determining search window data representing the set of offset positions applied to the search data by, for each offset position, selecting a corresponding portion of the search data; determining, for each offset position, a measure of similarity between the template data and the corresponding portion of the search data; and determining optical flow vector data comprising an optical flow vector corresponding to the template data by selecting an offset position of the set of offset positions based on the measures of similarity between the template data and the corresponding portions of the search data.

According to a seventh aspect of the present disclosure there is provided a computer implemented method for determining an optical flow vector for a rendered scene using template data and search data, the method comprising: generating motion vector data based on geometry data representing a rendered scene; obtaining template data derived from a portion of a first frame of image data representing the rendered scene; obtaining search data derived from a portion of a second frame of image data representing the rendered scene; and determining search window data by: for each offset position, selecting a corresponding portion of the search data; and selecting a further portion of the search data based on the motion vector data; determining, for each offset position, a measure of similarity between the template data and the corresponding portion of the search data; determining a measure of similarity between the template data and the further portion of the search data; and determining optical flow vector data comprising an optical flow vector corresponding to the template data by selecting either: an offset position of the set of offset positions; or the motion vector data, wherein the selecting is dependent on the measures of similarity.

According to a eighth aspect of the present disclosure there is provided a non-transitory computer-readable storage medium comprising computer-executable instructions which, when executed by a processor, cause the processor to: generate motion vector data based on geometry data representing a rendered scene; obtain template data derived from a portion of a first frame of image data representing the rendered scene; obtain search data derived from a portion of a second frame of image data representing the rendered scene; determine the set of offset positions using the motion vector data; and determine search window data representing the set of offset positions applied to the search data by, for each offset position, selecting a corresponding portion of the search data; determine, for each offset position, a measure of similarity between the template data and the corresponding portion of the search data; and determine optical flow vector data comprising an optical flow vector corresponding to the template data by selecting an offset position of the set of offset positions based on the measures of similarity between the template data and the corresponding portions of the search data.

According to a ninth aspect of the present disclosure there is provided a non-transitory computer-readable storage medium comprising computer-executable instructions which, when executed by a processor, cause the processor to: generate motion vector data based on geometry data representing a rendered scene; obtain template data derived from a portion of a first frame of image data representing the rendered scene; obtain search data derived from a portion of a second frame of image data representing the rendered scene; determine search window data by: for each offset position, selecting a corresponding portion of the search data; and selecting a further portion of the search data based on the motion vector data; determining, for each offset position, a measure of similarity between the template data and the corresponding portion of the search data; determine a measure of similarity between the template data and the further portion of the search data; and determine optical flow vector data comprising an optical flow vector corresponding to the template data by selecting either: an offset position of the set of offset positions; or the motion vector data, wherein the selecting is dependent on the measures of similarity.

### BRIEF DESCRIPTION OF THE DRAWINGS

FIG. 1 is a schematic diagram showing a block matching procedure according to examples.

FIG. 2 is a schematic diagram showing a processing system according to examples.

FIG. 3 is a flow diagram showing a method of determining an optical flow vector for a rendered scene using template data and search data according to examples.

FIG. 4 is a schematic diagram showing the processing system of FIG. 1 configured to perform the method of FIG. 2, according to examples.

FIG. 5 is a schematic diagram showing a set of offset positions being applied to search data to obtain search window data according to examples.

FIG. 6 is a schematic diagram showing a first example of the method of determining an optical flow vector for a rendered scene according to examples.

FIG. 7 is a schematic diagram showing a second example of the method of determining an optical flow vector for a rendered scene according to examples.

FIG. 8 is a schematic diagram showing a third example of the method of determining an optical flow vector for a rendered scene according to examples.

FIG. 9 is a schematic diagram showing a procedure for determining measures of similarity between template data and search data according to examples.

FIG. 10 is a schematic diagram showing a processing system that comprises a rendering engine, and execution engine, and a motion engine according to examples.

FIG. 11 is a schematic diagram showing the processing system of FIG. 10 performing a first example of method of determining an optical flow vector according to examples.

FIG. 12 is a flow diagram showing the first example of the method of determining an optical flow vector, as shown in FIG. 11, according to examples.

FIG. 13 is a schematic diagram showing a tensor that is determined when processing the template data and search data according to examples.

FIG. 14 is a schematic diagram showing the processing system of Figure performing a second example of a method of determining an optical flow vector according to examples.

FIG. 15 is a flow diagram showing the second example of the method of determining an optical flow vector, as shown in FIG. 11, according to examples.

FIG. 16 is a schematic diagram showing a process for generating motion vector data according to examples.

FIG. 17 is a schematic diagram showing a non-transitory computer-readable storage instructions for performing the method shown in FIG. 3, according to examples.

FIG. 18 is a schematic diagram showing a non-transitory computer-readable storage instructions for performing the method shown in FIG. 12, according to examples.

FIG. 19 is a schematic diagram showing a non-transitory computer-readable storage instructions for performing the method shown in FIG. 15. according to examples.

### DETAILED DESCRIPTION OF CERTAIN INVENTIVE EMBODIMENTS

Rendered graphics or rendered images are terms used to refer to visual representations generated by a rendering engine. These graphics are produced by converting raw data, such as 3D models, textures, and lighting information, into a 2D image or animation that can be displayed on a screen. Rendering is central process in computer graphics, video games, simulations, movies, computer generated images (CGI), virtual reality, and other visual media. Rendering engines take three-dimensional data and project it onto a two-dimensional plane (the screen), simulating depth, perspective, and lighting. The rendering process involves calculating how light interacts with surfaces to create realistic shadows, highlights, and reflections. Shading models, such as Phong, Blinn-Phong, or physically-based rendering (PBR) may be used to achieve these effects.

Textures are applied to 3D models to add detail and realism. Texture mapping involves wrapping a 2D image around a 3D object. After an initial rendering process, additional effects, such as bloom, depth of field, motion blur, and color correction can be applied to enhance the final image. Techniques to reduce jagged edges (aliasing) and make the rendered images appear smoother may also be applied, and are referred to as anti-aliasing.

Rendering can be used in a number of applications in both real-time and offline. Real-time rendering is used where images need to be generated quickly and interactively, such as video games and virtual reality. Real-time rendering engines aim to produce images at a high frame rate to ensure smooth motion and interaction. Offline rendering may be used in applications where image quality is prioritized over speed, such as in animated movies, visual effects, architectural visualization (including walk-around and walk-through videos). Offline rendering can take a significant amount of time per frame to generate, and in some cases minutes, or hours per frame, allowing for highly detailed and photorealistic images.

Video game graphics and virtual reality experiences are typically rendered in real-time allowing players to interact with dynamic and immersive environments that respond to character or user movements. Creating rendered images generally involves creating the 3D models that will be rendered, including defining the shapes, structures, and features of objects in the scene. Textures are applied to the models to give them color and detail. Light sources are defined within the scene to simulate real-world lighting conditions. Virtual camera positions are defined and configured, including field of view, perspective, focal lengths, and so forth. The rendering engine may then process all of this data and calculates the effects of lighting, shading, and texturing before producing the final 2D image based on the virtual cameras view. Projecting 3D objects onto a virtual cameras view, also referred to as projecting the rendered scene onto the screen plane, may involve several steps. Typically a set of transformations are applied to the data representing the rendered scene, these transformations may involve applying model, view, and projection matrices to object coordinates for the 3D objects in the scene.

In the context of computer graphics, optical flow is a useful tool that can be used in the application of temporal algorithms, such as: temporal anti-aliasing, framerate up-sampling, motion blur, and others. Optical flow calculation relates to techniques for estimating the motion of objects, surfaces, and edges in a visual scene between consecutive frames of image data representing that scene. Optical flow provides a way to track the movement of pixels from one frame to another. By tracking the movement of pixels from one frame to another, it is possible to interpolate the position of the pixels between the frames which enables upscaling techniques to be implemented by, for example, generating additional frames between two sequential frames.

A key concept in optical flow calculation is the determination of optical flow vectors. Optical flow algorithms may involve calculating a vector field where each vector represents the displacement of pixels between successive frames of image data. A variety of techniques for optical flow vector calculation are available including differential methods (such as the Horn-Shunck method or the Lucas-Kanade method), feature-based methods which detect specific features in the image and track these features across frames, phase-based methods which utilize the information of the image's Fourier transform to estimate motion, and block matching methods.

Block matching involves dividing a frame of image data into blocks and searching for the corresponding block in the next frame, or a previous frame, within a search window. In block matching, optical flow vectors are determined by finding a neighboring block in a previous or subsequent frame that has the highest similarity to a block in a current frame. Similarities between blocks are identified using an error metric to compare the blocks, wherein blocks pertaining to the lowest error are identified as a “match”. An optical flow vector may then be generated pointing from a current block and the block identified as a match. Optical flow vectors may be generated for blocks of pixels in the images or on a pixel-by-pixel basis.

Typically, calculating optical flow is a resource intensive operation. Exhaustively comparing blocks of a current frame with a previous frame to identify similarities can be a computationally expensive and slow operation. In real-time applications, block matching operations are costly to do at a native resolution of the image data because the number of blocks to search scales quadratically with resolution size.

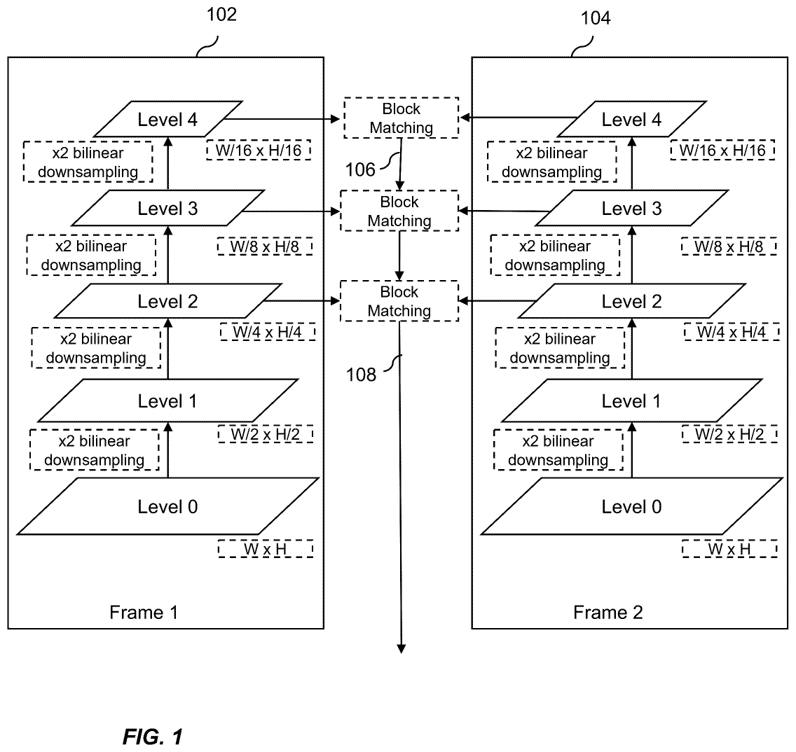

FIG. 1 shows an example of a pyramidal based approach which attempts to address these issues. The pyramidal based approach involves down sampling two image frames 102 and 104 to which block matching is to be applied and arranging the progressively down sampled image frames in two pyramid structures. Block matching is then performed first at the highest level, level 4, of the pyramids, representing the lowest resolution version of the image frames. An estimate of an optical flow vector 106 is determined at this lowest resolution, and then iteratively refined by moving up through the pyramid, at progressively up-sampled resolution versions of the image frames, and performing additional block matching to obtain a final optical flow vector 108. According to this technique, the highest-level, which is the lowest resolution, of the pyramid is responsible for capturing large motion disparities, and the lowest-level, which is the highest resolution, captures and refines optical flow vectors with small local disparities.

Optical flow approaches, such as block matching, are typically presented with a trade-off space between compute time and accuracy. Computing optical flow with higher accuracy typically requires greater compute time and/or compute resource expenditure. In the example described above, there are a number of parameters that can be tuned to control this trade off. For example, the size of the pyramid including the number of down-sampled layers, the number of blocks to search through, and the size of the blocks are tunable variables which can be controlled to affect the maximum detectable vector length, the confidence in the accuracy of the optical flow vector estimation, and the compute runtime. Applications which employ optical flow may therefore tune these variables to fit the accuracy and/or runtime budget of the use case.

In some cases, the pyramidal based approach may converge on a final optical flow vector before reaching the highest resolution versions of the image frames, and thereby reduce the computational cost that would be incurred if block matching was performed at the highest resolutions. Even where block matching is performed at the highest resolutions, using the optical flow vectors produced at lower resolutions enables less computational expense to be used at the highest resolutions because the parameters of block matching can be tuned to focus on more specific disparities between the image frames, for example, using smaller search windows.

Certain examples described herein relate to methods of modifying block matching techniques when processing image data representing a rendered scene, such as in a video game or virtual reality application, using information that is available to rendering engines. In one aspect described herein, an initial estimate of an optical flow vector for a rendered scene can be obtained using geometry data associated with the rendered scene. Block matching may then be used to refine the determination of the optical flow vector. Initializing an optical flow vector using a motion vector generated using geometry data for a rendered scene increases the likelihood of the block matching procedure converging on an accurate optical flow vector more quickly than if the process is initiated assuming no motion.

In another aspect described herein, the block matching procedure may be supplemented by, for each search operation that attempts to match a block in a current frame to a block in a neighboring frame using a search window, adding an additional candidate block from the neighboring frame using motion vector data generated using geometry data associated with the rendered scene.

In the context of rendered images, such as in video games, virtual reality, or other rendered scenes, motion information may be derived from the 3D models that are processed by the rendering engine. For example, in the context of computer graphics, motion vectors generated by a rendering engine, also referred to as rendered motion vectors, describing the disparity between rendered vertices, can be generated relatively inexpensively. Such calculations may involve using geometry data such as a depth buffer along with a camera model, view, and projection matrices. As these motion vectors rely on geometry data they can be considered as a more accurate, or “ground-truth”, quality estimation of motion in a rendered scene.

Rendered motion vectors are useful in determining movement of fixed-geometry objects in a scene, for example, the motion of rendered objects, edges, and vertices. Rendered motion vectors are generally not used to represent disparities in images of objects that are not representable using fixed geometry, such as lighting effects, shadows, particles, and so forth. Within the context of temporal algorithms such as up-sampling, anti-aliasing and so forth, the exclusive use of rendered motion vectors can cause undesired artefacts in the resulting frames of image data. These artefacts may include low-frame rate shadows that present as temporal flickering.

By using rendered motion vectors to modify, or supplement, block matching procedures as disclosed herein, it is possible to reduce the computational cost of block matching while achieving greater motion vector accuracy and avoiding potential undesirable effects that may arise from using rendered motion vectors alone.

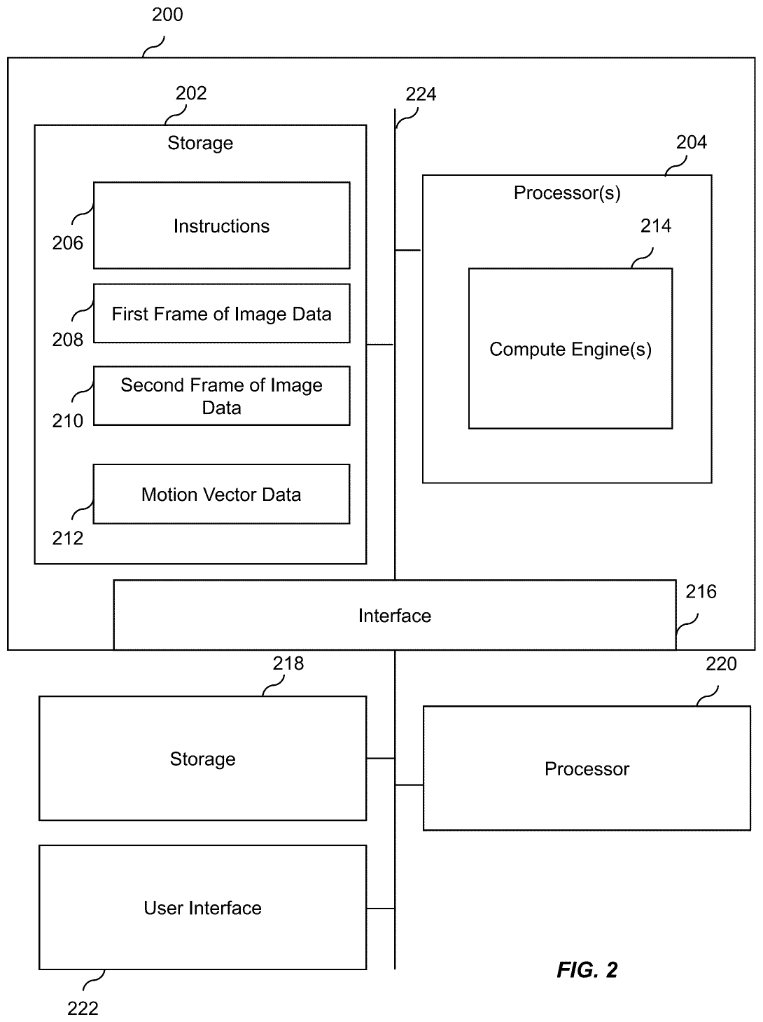

Various examples of the present disclosure will now be described with respect to FIGS. 2 to 19. Various elements or components are omitted or simplified in some Figures to aid intelligibility. FIG. 2 illustrates a processing system 200 configured to determine optical flow vector data comprising an optical flow vector for a rendered scene using template data and search data. The processing system 200 comprises circuitry that is configured to cause the processing system to perform a computer-implemented method of determining optical flow vector data for a rendered scene. For example, the processing system 200 comprises one or more processors 204 or processing circuits that may be configured to perform the method of determining optical flow vector data.

The processing system 200 shown in FIG. 2 comprises storage 202. The storage 202 may store computer-executable instructions 206 that, when executed, cause the processing system 200 to perform the method of determining optical flow vector data. The storage 202 may alternatively, or additionally, be used to store other types of data including a first frame of image data 208, a second frame of image data 210, and motion vector data 212 that will be described further below with respect to the method. The storage 202 includes a suitable combination of volatile storage such as random-access memory (RAM) and/or non-volatile storage such as read only memory (ROM).

The processor(s) 204 may include any suitable combination of general and/or application specific processing circuitry. For example, the processor(s) may include any of a central processing unit (CPU), a general processing unit (GPU), accelerated processing units (APUs), tensor processing units (TPUs), application specific integrated circuits (ASICs), fixed programmable gate arrays (FPGAs), or any other suitable combination of these and other processor types.

In the example shown in FIG. 2, the processor(s) 204 includes one or more compute engines 214 that are configured to perform convolutional operations, such as Multiply Accumulate (MAC) operations, accumulate operations, and/or applying sum of absolute difference calculations to tensors. The compute engines 214 may be implemented using fixed hardware processing circuitry such as application specific integrated circuits (ASICs), fixed programmable gate arrays (FPGA), and/or general-purpose processing units such as a CPUs or GPUs. The processing system 200 includes an interface 216 that is configured to handle communications between the processing system 200 and one or more external components, such as storage 218, processors 220, and user interfaces 222. The interface 216, storage 202, and the processor(s) 204 are communicatively couple using a bus 224.

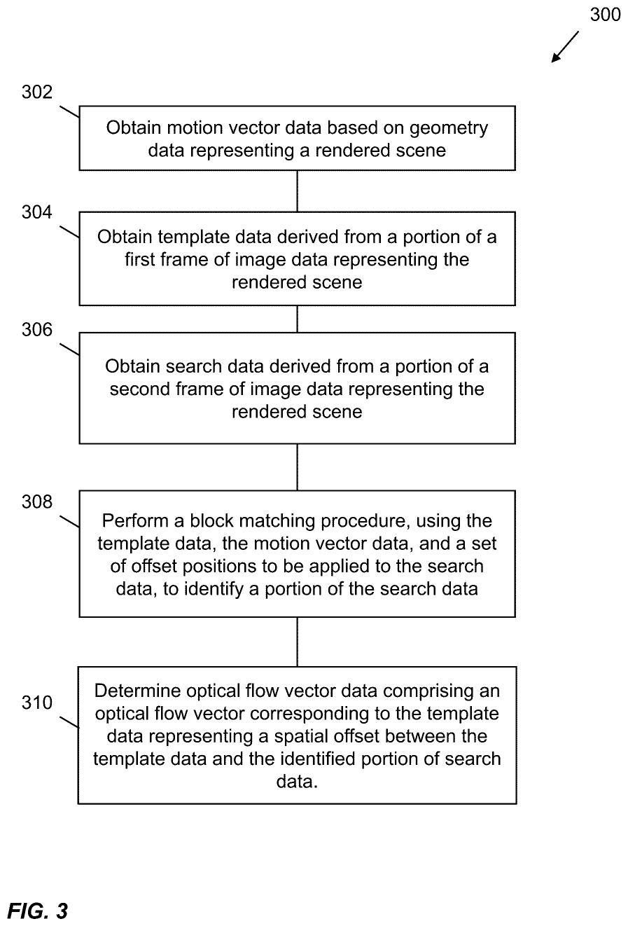

The processing system 200 may be included in a computing device, such as a server, a personal computer, or a mobile computing device, which includes its own storage 218, processor 220, and user interface 222. The processor 204 of the computing device may be configured to instruct the processing system 200 to conduct the method of determining optical flow vector data, which will be described further below with respect to FIGS. 3 to 9, and may provide the relevant data or instructions to the processing system 200 to perform these functions.

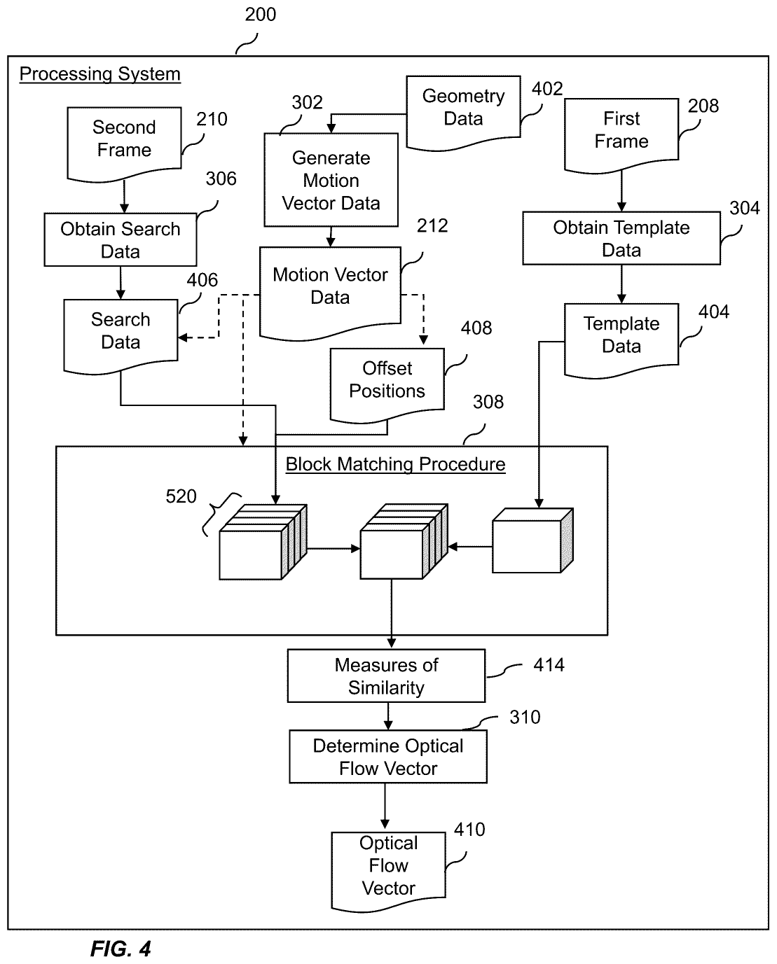

FIGS. 3 and 4 show the method 300 of determining optical flow vector data for a rendered scene that the processing system 200 is configured to perform. The processing system 200 obtains 302 motion vector data 212 based on geometry data 402 representing the rendered scene. The motion vector data 212 may also be referred to rendered motion vector data 212 to distinguish it from other forms of motion vector data determined using alternative techniques. The geometry data 402 may include 3D model data, representing objects and/or the environment of the rendered scene, texture data, transform data for generating rendered images based on the 3D scene, and other relevant geometric data described above with respect generating rendered graphics.

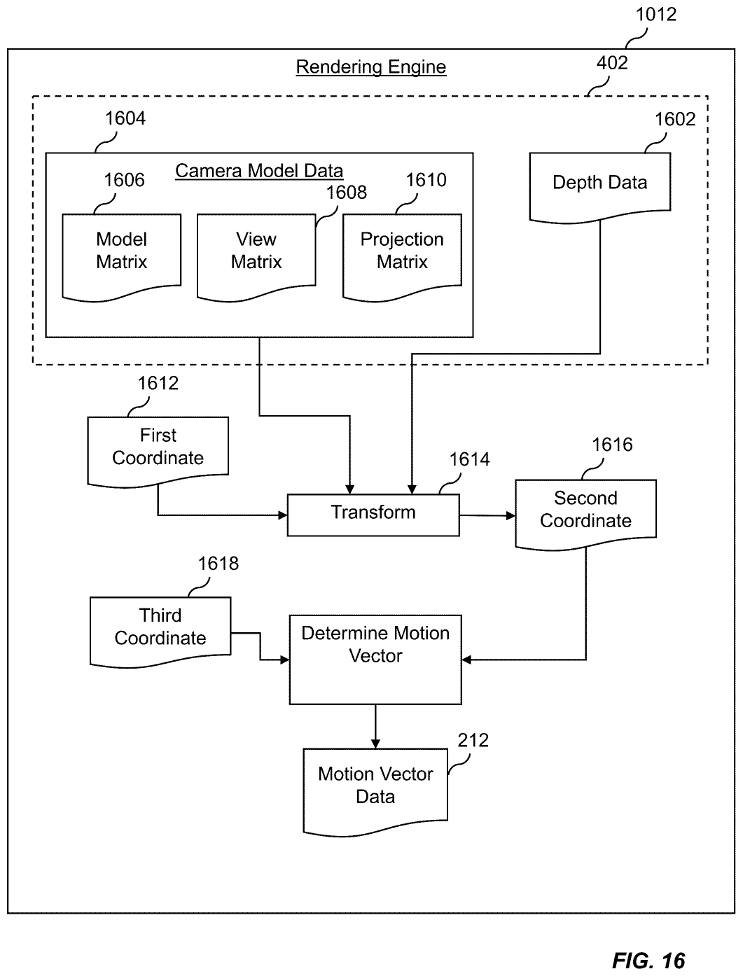

In the example shown in FIG. 2, the storage 200 comprises a first frame of image data 208 and a second frame 210 of image data. These frames of image data 208 and 210 are rendered images generated, for example, based on a 3D model of the rendered scene. The motion vector data 212 may comprise one or more motion vectors representing motion between the first frame of image 208 and the second frame of image data 210. The motion vectors may represent movement between individual pixels or blocks of pixels between the first frame of image data 208 and the second frame of image data 210. The motion vector data 212 is obtained using geometry data representing the rendered scene. Examples of processes for obtaining motion vector 212 are described further below with respect to FIG. 16.

Template data 404, derived from a portion of the first frame of image data 208, is obtained by the processing system 200. The template data 404 may include a block of image data derived from the first frame of image data 208, wherein a block comprises a group of pixels representing a region of the first frame of image data 208.

The processing system 200 obtains search data 406, derived from a portion of the second frame of image data 210 representing the rendered scene. The search data 406 may similarly include a block of image data but derived from the second frame of image data 210, including a group of pixels representing a region of the second frame of image data 210. The first frame of image data 208 and the second frame of image data 210 are different frames of image data representing the rendered scene. For example, the first frame of image data 208 and the second frame of image data 210 may represent the rendered scene at two different times. In the examples discussed herein, the first and second frames of image data 208 and 210 are sequential frames of image data, the second frame 210 being a previous frame and the first frame 208 being a current, or subsequent frame. It is to be appreciated, however, that other examples are possible. For example, the first frame 208 may be the previous frame and the second frame 210 may be the current or subsequent frame. Alternatively, the first and second frames of image data 208 and 210 may represent the rendered scene at the same time but according to different views of the rendered scene.

The search data 406 generally represents a larger block of image data than the template data 404. For example, where the template data 404 comprises a 3×3 pixel region derived from the first frame of image data 208, the search data 406 may comprise a 9×9 pixel region derived from the second frame of image data 210. The search data 406 represents a region within the second frame of image data 210 for which a match to the template data 404 is to be identified. In other examples, the portion of the second frame of image data 210 used to derive the search data 406 may include the whole of the second frame of image data 210.

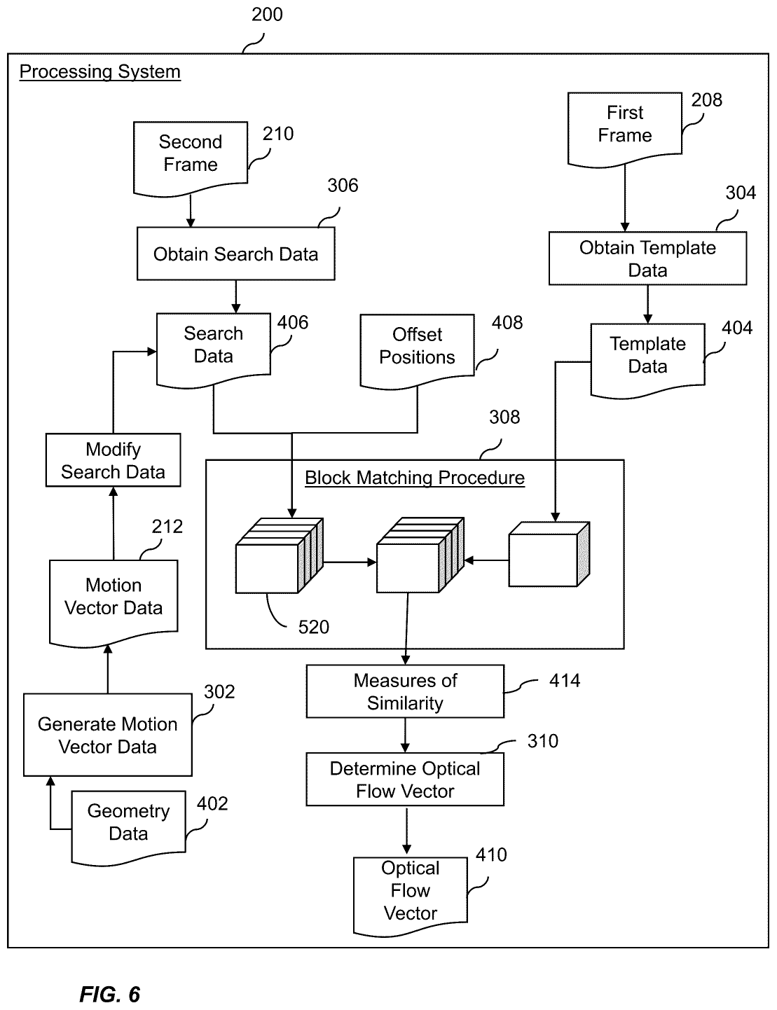

A block matching procedure is performed 308 by the processing system 200. The block matching procedure uses the template data 404, the motion vector data 212, and a set of offset positions 408 to be applied to the search data 406, to identify a portion of the search data 406. The motion vector data 212 may be used during the block matching procedure in various ways which will be described further below with respect to FIGS. 6 to 9. The processing system 200 then determines 310 optical flow vector data 410 comprising an optical flow vector corresponding to the template data 404 representing a spatial offset between the template data 404 and the identified portion of search data 406. The optical flow vector data 410 may be produced at various levels of precision. For example, the optical flow vector data 410 may represent movement between blocks of pixel locations between the first frame of image data 208 and the second frame of image data 210. Alternatively, the optical flow vector data 410 may represent pixel level, or sub-pixel level, motion between the first frame of image data 208 and the second frame of image data 210.

The method 300 may be repeated to determine optical flow vectors for a plurality of portions of the first frame of image data 208, whereby the resulting optical flow vector data 410 comprises a plurality of optical flow vectors. For example, the method 300 may be repeated wherein the template data 404 and the search data 406 are derived from different portions of the first frame of image data 208 and the second frame of image data 210 respectively. In this way, the method 300 may be used to determine optical flow vectors for a plurality of blocks of image data in the first frame of image data 208. The method 300 may also be repeated at various resolutions. With respect to the example of FIG. 1, the method 300 may be employed at any of the levels of the pyramidal structure.

Motion vector data 212 may be available to the processing system 200, or produced at low additional cost, in a number of applications, such as when rendering graphics for a video game, or providing other functions for processing rendered scenes. As discussed above, motion vector data 212 provides highly accurate motion estimations for objects in the rendered scene which are representable using fixed geometry. Motion vector data 212 is not generally suitable for estimating motion of elements in a rendered scene which are not representable using fixed geometry such as lighting and particle effects. By using the motion vector data 212 in a block matching procedure, it is possible to increase the accuracy and/or reduce the computational cost of performing 308 block matching, while still using block matching to accurately determine optical flow vectors that are suitable for elements in the rendered scene that are not represented using fixed geometry and thereby avoiding potential artefacts that may occur if motion vector data 212 is used alone.

Performing 308 block matching procedures may generally involve a trade off between accuracy of the prediction and computational resources. Both the accuracy and computational complexity of block matching procedures are dependent on tunable parameters such as the size of a search window applied to the search data 406 and the number of comparisons between template data 404 and the search data 406. By using the motion vector data 212 during the block matching procedure it becomes possible to increase the accuracy of motion estimation using block matching whilst mitigating an increase in computational resources that may otherwise be incurred when increasing the accuracy. For example, the accuracy of block matching can be increased without having to select larger search windows, or use a large number of additional comparisons between the template data 404 and portions of the search data 406 within the search window. For the same accuracy of motion estimation, the computational cost of block matching may be reduced by using the motion vector data 212.

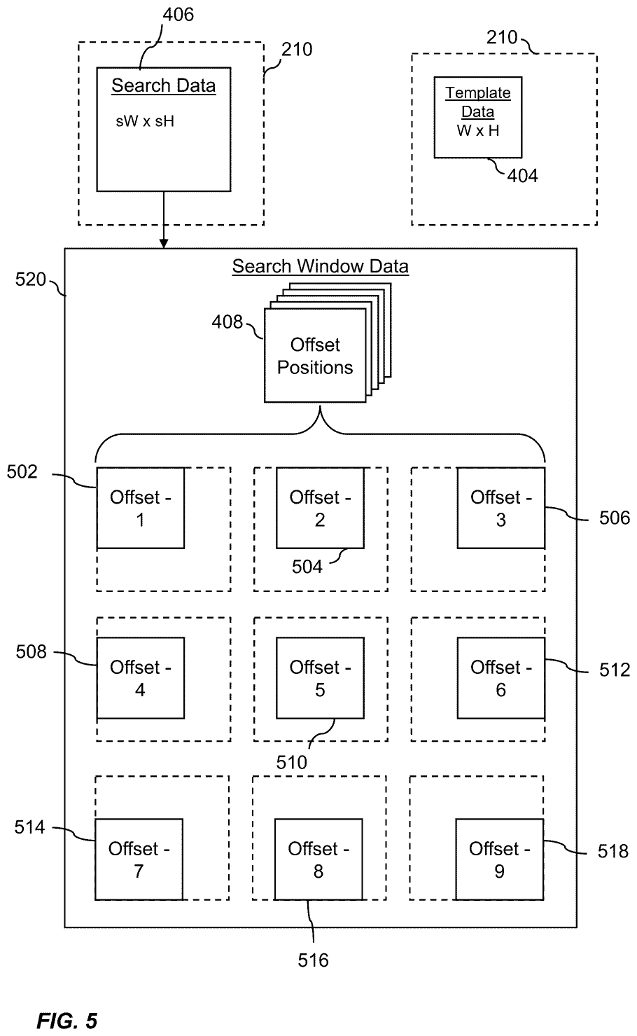

Turning to FIG. 5, an example of a first frame of image data 208, template data 404, a second frame of image data 210, and search data 406 is shown. Frames of image data may generally include an array of pixel values, each pixel value being associated with a respective pixel location in the frame of image data. Each pixel location in a frame of image data may be represented using a plurality of pixel values, for example, including a pixel value representing the luminosity, or “luma”, of the associated pixel location, and pixel values representing chroma, or color, components.

A frame of image data may include several channels of pixel values, each channel representing a different characteristic of the frame of image data. One channel may represents the luminosity of the pixel locations, and one or more other channels may represent color information for the pixel locations, such as the intensity of red, green, or blue (RGB). The examples described herein are provided with reference to only a single channel of the first and second frames of image data 208 and 210 for simplicity. However, it will be appreciated that these examples may also be applied to multiple channels of frames of image data, including luminosity and any one or more chroma channel (RGB).

The template data 404 is derived from a portion of the first frame of image data 210, for example, by selecting a portion of the first frame of image data 210, the selected portion having dimensions W×H. The template data 404 includes W×H pixel values of the first frame of image data 210. Deriving the template data 404 from the first frame of image data 210 may involve applying one or more pre-processing, compression, or decompression techniques prior to selecting a portion of the first frame of image data 210.

The search data 406 is derived from a portion of the second frame of image data 210, for example, by selecting a portion of the second frame of image data 210. The selected portion has dimensions sW×sH, wherein size of the portion sW×SH may be referred to as a search window. The second frame of image data 210 may be pre-processed, compressed, or decompressed prior to selecting portions of the second frame of image data 210 to derive the search data 406. The search data 406 includes sW×sH pixel values of the second frame of image data 210. The dimensions of the search data 406 sW×sH may generally be larger than the dimensions of the template data 404 W×H. A relative position of the portion of the second frame of image data 210, from which the search data 406 is derived may correspond, or be similar, to a relative position of the portion of the first frame of image data 208 from which the template data 404 is derived.

Search window data 520 may be obtained by applying a set of offset positions 408 to the search data 406 and selecting the corresponding portions of search data 406 that overlap with the offset positions. The set of offset positions 408 may be represented by offset data stored in the storage 202 in the processing system 200 and/or may be selectable. FIG. 5 shows nine offset positions 502 to 518 in the set of offset positions 408 to be applied to the search data 406. Each offset position has a pre-determined size and relative position amongst the set of offset positions 408. The offset positions 502 to 518 have dimensions that match the dimensions, W×H, of the template data 404. For each offset position 502 to 518 a portion of the search data 406, specifically a subset of the pixel values represented in the search data 406, is selected.

The search window data 520 comprises a plurality of arrays of pixel values each corresponding to one of the selected portions of the search data 406. References to a portion of search window data 520 herein generally refer to one of these arrays of pixel values that corresponds to a respective selected portion of search data 406, unless stated otherwise. For example, where reference is made to selecting, or identifying a portion of search window data, it is to be understood that the portion of search window data 520 corresponds to a respective portion of search data 406 that has been selected by applying an offset position, or otherwise, to the search data 406.

Returning to FIG. 4, the portions of search window data 520, each comprising respective selected portions of the search data 406 for the offset positions 502 to 518, may be compared with the template data 404 to determine a measure of similarity 414. The measures of similarity 414 are indicative of a difference between the template data 404 and a respective portion of search window data 520. An offset position is then selected based on the measures of similarity, for example, by selecting the offset position that corresponds to a portion of the search window data 520 that is most similar to the template data 404.

The portion of search window data 520, which is most similar to the template data 404, comprises the identified portion of search data 406 that is subsequently used to determine the optical flow vector data 410.

Determining differences between the template data 404 and respective portions of search data 406 may involve applying calculations such as sum of squared differences (SSD), sum of absolute differences (SAD), cross-correlation (CC), normalized cross correlation (NCC), mutual information (MI), gradient based methods, or any other suitable techniques.

To balance the trade off between accuracy and complexity when performing block matching, the number of offset positions, the relative position of the offset positions, and the size of the template data 404 and the offset positions 408 may be tuned. The set of offset positions 408 may be selected from one or more candidate sets of offset positions. In the examples shown, the template data 404, search data 406, and search window data 520 all comprise square two-dimensional arrays of pixel values. It will be appreciated, however, that other shapes are also possible including rectangles, ellipses, other regular polygons, or uniquely defined shapes.

The optical flow vector data 410 may be represented as a relative spatial offset between the template data 404 and the identified portion of search data 406. Typically, the optical flow vector data 410 may be represented using a two-dimensional array including a first value indicative of a spatial offset in the horizontal, or x-axis, direction and a second value indicative of a spatial offset in the vertical, or y-axis, direction. In the example shown in FIG. 5, the portions of search data 406 have a spatial offset to the template data 404 that corresponds to their respective offset positions wherein:
(a) Offset position “Offset-5”, has a relative spatial offset to the template data of (0, 0) in x, y coordinates.
(b) Offset position “Offset-1”, has a spatial offset to the template data of (−1, 1) in x, y coordinates.
(c) Offset position “Offset-2”, has a spatial offset to the template data of (0, 1) in x, y coordinates.
(d) Offset position “Offset-3”, has a spatial offset to the template data of (1, 1) in x, y coordinates.
(e) Offset position “Offset-4”, has a spatial offset to the template data of (−1, 0) in x, y coordinates.
(f) Offset position “Offset-6”, has a spatial offset to the template data of (1, 0) in x, y coordinates.
(g) Offset position “Offset-7”, has a spatial offset to the template data of (−1,−1) in x, y coordinates.
(h) Offset position “Offset-8”, has a spatial offset to the template data of (0,−1) in x, y coordinates.
(i) Offset position “Offset-9”, has a spatial offset to the template data of (1,−1) in x, y coordinates.

In other examples, the relative spatial offset of the offset positions may be different, for example, offset position “Offset-3” may be defined as having a spatial offset of (0, 0) compared to the template data 404. The incremental and/or maximum absolute spatial offset between each of the offset positions may also be greater than (1, 1) as shown. For example, each offset position 502 to 518 may represent an offset of up to two or more pixel locations in the horizontal and/or vertical direction.

FIG. 6 shows a first example of using the motion vector data 212 when performing 308 the block matching procedure. In the first example, the processing system 200 modifies the search data 406 according to the motion vector data 212. Modifying the search data 406 may involve updating the search data 406 such that it is derived from a different portion of the second frame of image data 210, which may be overlapping or completely different to the portion of the second frame of image data 210 from which the search data 406 is initially derived.

By modifying the search data 406 according to the motion vector data 212 in this way, the modified search data that is to be used in the block matching procedure is more likely to include a portion of the search data 406 that represents a good match to the template data 404. For example, where motion between the first and second frames of image data 208 and 210 is large, the portion of the second frame of image data 210 from which the search data 406 is initially derived may represent a substantially different part of the rendered scene than the portion of the first frame of image data 208 from which the template data 404 is derived. By modifying the search data 406 using the motion vector data 212 it is possible to obtain search data 406 representing a more suitable portion of the second frame of image data 210, for example, that is more likely to include a “match” with the template data 404. Without the use of the motion vector data 212, the optical flow vector determined using block matching may represent a poor match, or may necessitate the use of a larger search window to improve the accuracy, thereby increasing the computational cost of performing 308 block matching.

Alternatively, or additionally, modifying the search data 406 may involve warping the search data 406, for example, warping the geometry of the search data 406 by a transformation or distortion operation. Transforming or distorting the search data 406 may involve stretching, compressing, rotating, or bending the search data based on the motion vector data 212. In practice, this may involve applying a matrix transformation that modifies the defined pixel locations of the pixel values in the search data 406 based on the motion vector data 212. As a result, when the offset positions 408 are applied to the search data 406, different portions of search data 406 are selected for each offset position compared to the portions of search data 406 that would otherwise be selected when using non-warped search data.

By modifying the search data 406 according to the motion vector data 212 in this way, the modified search data 406 that is to be used in the block matching procedure is more likely to include a portion of search data 406 that represents a good match to the template data 404. In some circumstances, motion between frames of image data 208 and 210 is not uniform across the rendered scene, meaning that some regions in the rendered scene move at different rates between the first and second frames of image data 208 and 210. This can occur when the camera view rotates, the perspective or focal length shifts, or other distorting motions occur between frames. Warping the search data 406 based on the rendered motion data 212 enables non-uniform motion to be accounted for when determining search data 406 that is to be compared with the template data 404 during the block matching procedure.

After modifying the search data 406, search window data 520, as shown in FIG. 5, may then be determined by selecting a corresponding portion of the modified search data 406 for each of the offset positions. As before, measures of similarity 414 may be determined between the template data 404 and the corresponding portions of the search window data 406, now derived from the modified search data. An offset position may then be selected based on the measures of similarity 414, for example, by comparing the search window data 520 with the template data 404 to identify the portion of modified search data that is most similar to the template data 404.

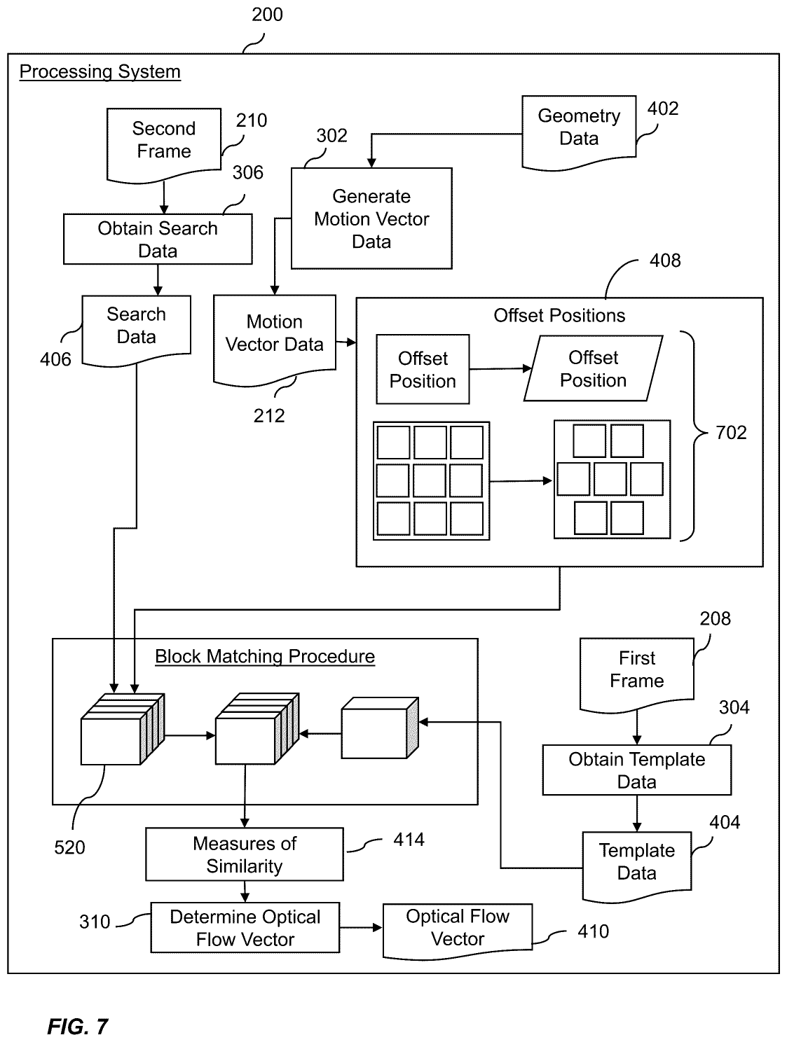

In a second example, shown in FIG. 7, the motion vector data 212 may be used to modify the set of offset positions 408. This may involve using the motion vector data 212 to modify the offset positions 408 such that they are more likely to correspond to portions of search data 406 that are similar to the template data 404. Modifying 702 the set of offset positions 408, as shown in FIG. 7, may involve applying a spatial bias, changing the relative position of one or more offset positions with respect to the other offset positions, and/or modifying the total number of offset positions which are to be applied to the search data 406, by adding or removing one or more of the set of offset positions 408.

Alternatively, or additionally, modifying 702 the set of offset positions 408 may involve warping the set of offset positions 408, for example by transforming or distorting one or more of the offset positions which are to be applied to the search window data 520. Warping the offset positions 408 may involve stretching, compressing, rotating, or bending any one or more of the offset positions based on the motion vector data 212.

By modifying 702 the set of offset positions 408 using the motion vector data 212 prior to applying the offset positions 408 to the search data 406, the processing system 200 may increase the likelihood that the search window data 520 includes a good match to the template data 404.

The search window data 520 may then be determined by applying the set of modified offset positions 408 to the search data 406 and, for each offset position, selecting a corresponding portion of the search data 406. For each modified offset position 408, a measure of similarity 414 between the template data 404 and the corresponding portion of search window data 520 may be determined and used to select an offset position and determine an optical flow vector data 410.

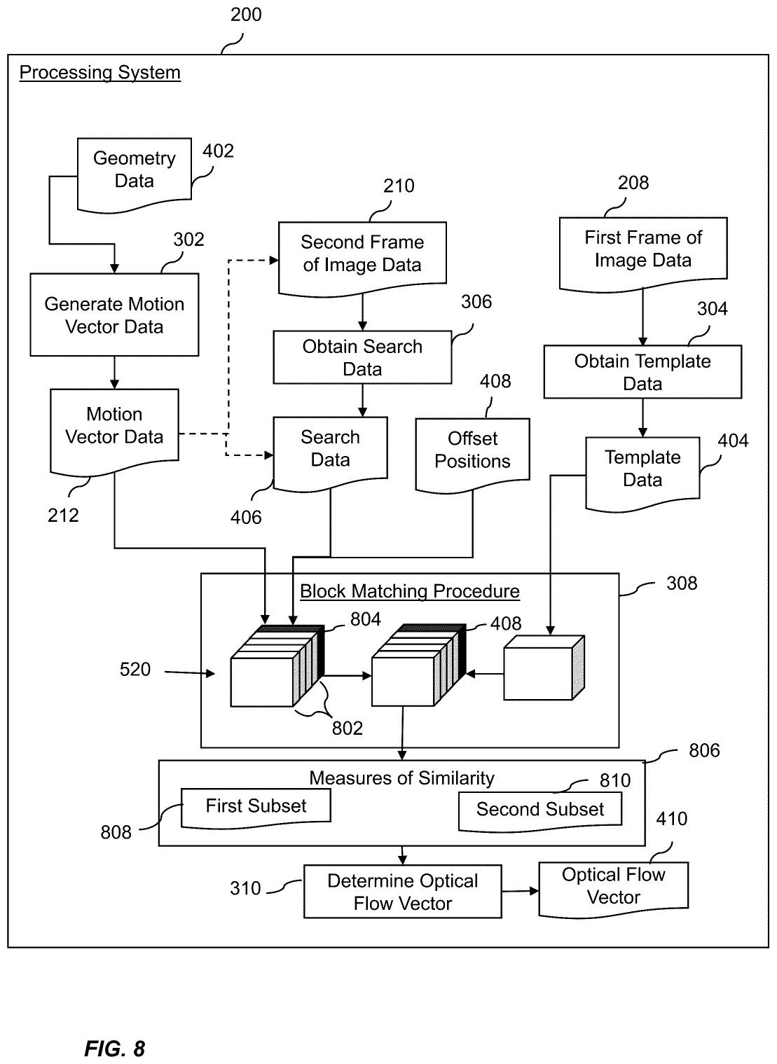

In a third example, shown in FIG. 8, performing 308 the block matching procedure involves selecting a further portion of search data 406 using the motion vector data 212. In this example, the search window data 520 is determined by applying the set of offset positions 408 to the search data 406, selecting corresponding portions of search data 802, and additionally selecting a further portion of search data 804 using the motion vector data 212. The further portion of search data 804 selected using the motion vector data 212 is shown in FIG. 8 as an additional block of the search window data 520 colored black. The further portion of search data 804 may be obtained from the search data 406, or derived from the second frame of image data 210. For example, where the motion vector data 212 indicates a region in the search data 406 that has already been derived from the second frame of image data 210, the further portion of search data 804 may be selected from the search data 406. Alternatively, where the motion vector data 212 indicates a region that is outside of the portion of the second frame of image data 210 from which the search data 406 is derived, the further portion of search data 804 may be selected from the second frame of image data 210. The further portion of search data 804 may generally represent a region in the second frame of image data 210 that is spatially offset to the template data 404 by a distance and direction indicated in the motion vector data 212.

A plurality of measures of similarity 806, also referred to as a plurality of similarity measures, that are indicative of a difference between the template data 404 and a respective portion of the search window data 520 are then determined. The plurality of similarity measures 806 include a first subset of similarity measures 808 and a second subset of similarity measures 810. The first subset of similarity measures 808 are each indicative of a difference between the template data 404 and a corresponding portion of the search data 802 associated with a respective offset position. The second subset of similarity measures 810 includes one or more similarity measures that are indicative of a difference between the template data 404 and the further portion of the search data 804 selected using the motion vector data 212.

A portion of the search data is identified by selecting either an offset position or the motion vector data 212 based on the plurality of similarity measures 806. The plurality of similarity measures 806 may be compared to identify a corresponding portion of search data that is most similar to the template data 404. As described above with respect to FIGS. 4 to 7, this may involve comparing the similarity measures 806 and selecting a portion of search data 802 or 804 that is most similar to the template data 404.

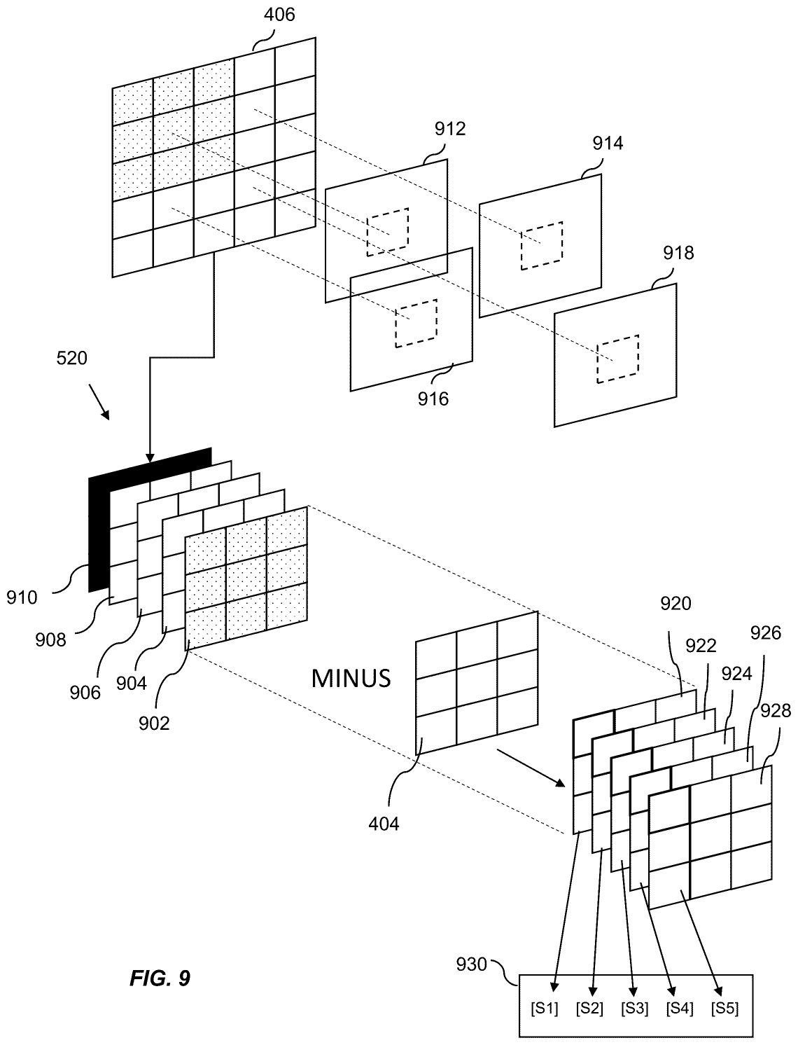

FIG. 9 shows an example of determining measures of similarity 930 between the template data 404 and portions of search window data 902 to 910. In this example, the search data 406 comprises an a 5×5 array of pixel values derived from the second frame of image data 210. The search window data 520 includes a plurality of portions 902 to 910, each portion 902 to 910 including a 3×3 array of pixel values. Four of the portions 902 to 908 of search window data 520 are determined by applying a set of four offset positions 912 to 918 to the search data 406. In this example, the offset positions 912 to 918 correspond to uniformly spaced subsets of the search data 406 that are partially overlapping. It will be appreciated, however, that in other examples, the offset positions 912 to 918 may not be uniformly spaced or overlapping.

A fifth portion of search window data 910 that is obtained using the motion vector data 212 is also shown, in black. The fifth portion 910 may include a subset of the search data 406 that partially overlaps with one or more of the set of offset positions 912 to 918. For example, the four offset positions 902 to 918 may each overlap with a different corner of the search data 406 and the fifth portion of search window data 910 may be derived from portions of the search data 406 that do not overlap with the corners of the search data 406.

Each of the portions 902 to 910 of the search window data 520 may be processed using the template data 404 to obtain a set of difference values 920 to 928 representing a difference between the template data 404 and the respective portion of search window data 902 to 910. This may involve subtracting the pixel values in the template data 404 from the corresponding, that is overlapping, pixel values in the portions of search window data 902 to 910. The set of difference values 920 to 928 for a portion of search window data 902 to 910 may then be summed to obtain a measures of similarity 930 that is indicative of a total difference between the template data 404 and the respective portion of search window data 902 to 910. This may involve using a sum of absolute differences, or other similar techniques, that are suitable for determining differences between the template data 404 and the portions of the search window data 902 to 910.

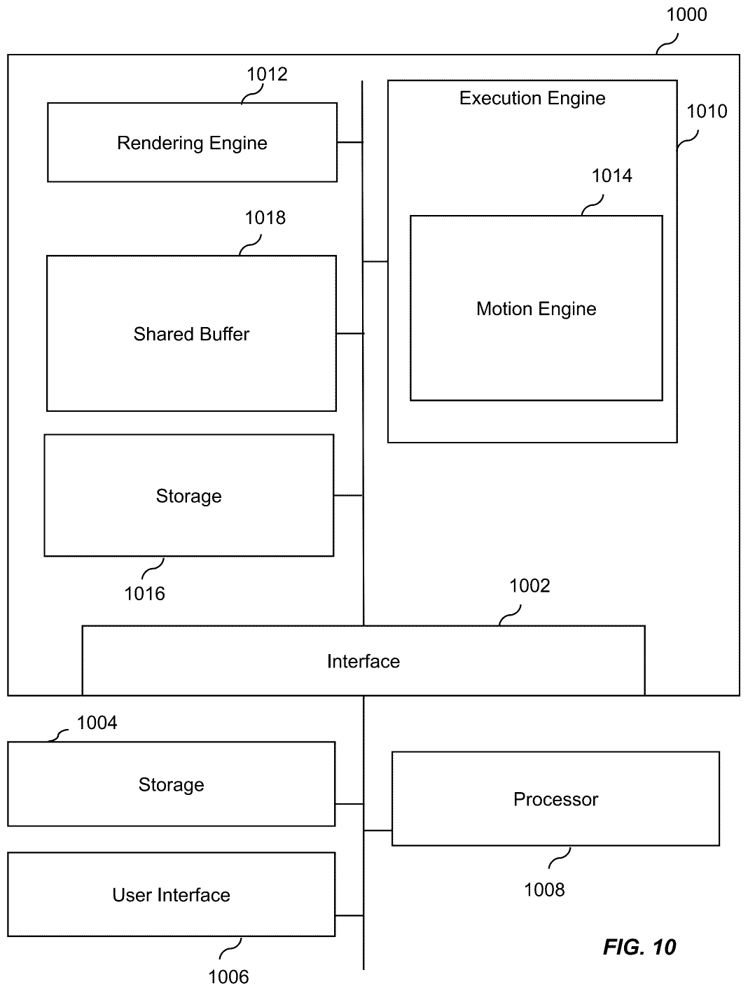

FIG. 10 shows a more specific example of a processing system 1000 for processing template data and search data according to a search window applied to the search data. The processing system 1000 may be a processing unit that is integrated into a computing device such as a personal computer, server, or mobile device such as a smartphone or tablet computer. In the example shown, the processing system 1000 is connected, via an interface 1002, to a storage 1004, a user interface 1006, and a processor 1008. The processor 1008 may be a general purpose central processing unit (CPU) of the computing device that is configured to perform general processing functions. The storage 1006 may include any suitable combination of volatile and/or non-volatile storage such as a combination of random-access memory (RAM) and read-only memory (ROM).

The processing system 1000 may include dedicated hardware, such as processing circuitry and a combination of volatile and non-volatile storage, for supporting graphics-based image and model processing functions. These graphic based functions may include rendering graphics for a video game, simulations, computer assisted drawing, virtual reality, or other application in which rendered graphics are used. In some examples, the processing system 1000 may be implemented as part of, or in combination with, a graphics processing unit (GPU) or other type of processor.

The processing system 1000 comprises a rendering engine 1010, an execution engine 1012, and a motion engine 1014. Each of the execution engine 1010, the rendering engine 1012, and the motion engine 1013 may be implemented using a suitable combination of software and or hardware componentry. In some examples, the rendering engine 1012, execution engine 1010, and motion engine 1014 share processing resources such as processing circuitry including one or more processing units and/or general purpose processors. Storage 1016 in the processing system 1000 may include computer-implemented instructions, or program code which, when executed on the shared processing resources, implement any one or more of the rendering engine 1012, execution engine 1010, and motion engine 1014. One or more of the rendering engine 1012, execution engine 1010, and motion engine 1014 may alternatively, or additionally, be implemented using dedicated hardware. Further detail regarding the implementation of dedicated hardware will be discussed further below.

The rendering engine 1012 is a software and/or hardware component that is used to perform graphics and/or image processing functions such as converting data into visual images. The rendering engine 1012 may be responsible for a variety of processing functions such as 3D model processing, transformation, lighting and shading simulations, texture mapping, rasterization of 3D objects into 2D images, anti-aliasing, and post processing.

The execution engine 1010 is a software and/or hardware component that configured to perform control functions for processing image data and graphics rendering. For example, the execution engine 1010 may be configured to control motion estimation operations as will be described further below. In the example shown in FIG. 10 the execution engine 1010 comprises the motion engine 1014. The motion engine 1014 is configured to perform low level operations to facilitate block matching procedures in response to instructions from the execution engine 1010.

The processing system 1000 also includes a shared buffer 1018 that is accessible to the execution engine 1010, the motion engine 1014, and the rendering engine 1012. The shared buffer 1018 may be used to temporarily store data that is output from or to be processed by the rendering engine 1012, execution engine 1010, and the motion engine 1014. For example, the execution engine 1010 may use the shared buffer 1018 to temporarily store motion vector data 212, search data 406, and/or template data 404 while performing block matching using the motion engine 1014.

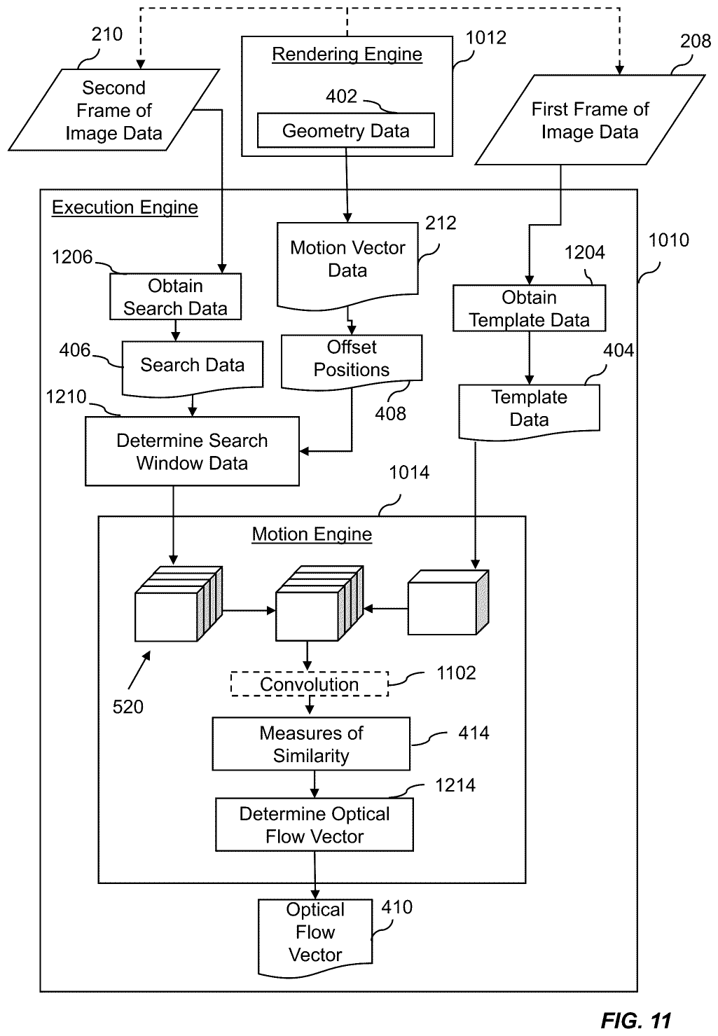

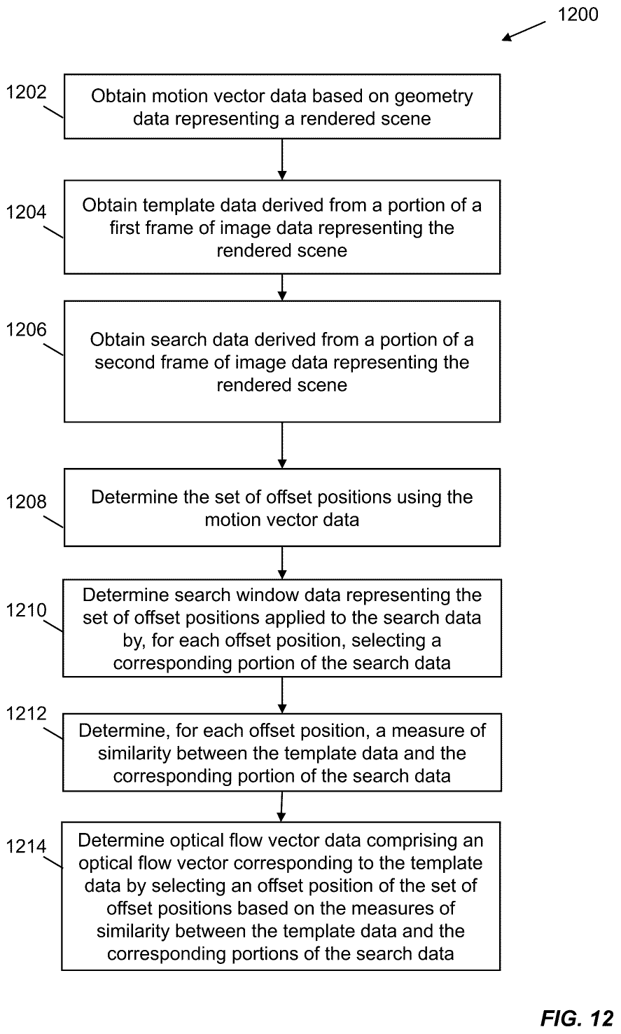

FIGS. 11 and 12 show a detailed example of how the processing system 1000 may be configured to perform a computer-implemented method 1200 for determining an optical flow vector data 410 similar to the examples described above with reference to FIGS. 4 and 7. The rendering engine 1012 is configured to generate 1202 motion vector data 212 based on geometry data 402 representing a rendered scene. The rendering engine 1012 provides the motion vector data 212 to the execution engine 1010.

The execution engine 1010 obtains 1204 template data 404 derived from a portion of a first frame of image data 208 and obtains 1206 search data 406 derived from a portion of a second frame of image data 210. The template data 404 and search data 406 may be derived as described above with respect to FIGS. 3 to 7, wherein the template data 404 and search data 406 each comprise a two-dimensional array of pixel values derived from the first frame of image data 208 and the second frame of image data 210 respectively. As noted above, the examples described herein a provided with respect to a single channel of pixel values in the first frame and the second frame of image data 208 and 210. In implementations where multiple channels, such as luma and chroma, are present in the first frame and the second frame, the template data 404 and search data 406 may comprise three-dimensional arrays of pixel values.

The first and second frames of image data 208 and 210 may be generated using the rendering engine 1012 such as where the rendering engine 1012 is configured to process 3D model data for a scene and to generate rendered image data representing the scene. In other examples, the first and second frame of image data 208 and 210 may be obtained from alternative sources. The processing system 1000 may comprise image processing engines which are configured to perform image processing operations to support the rendering engine 1012. In this case, the first frame of image data 208 and the second frame of image data 210 may be obtained from an image processing engine, not shown in the Figures.

The execution engine 1010 uses the motion vector data 212 to determine 1208 a set of offset positions 408. Determining 1208 the set of offset positions 408 may involve identifying an initial set of offset positions and modifying the initial set of positions using the motion vector data 212 to obtain the set of offset positions 408.

Identifying the initial set of offset positions may involve selecting one or more characteristics of the offset positions including the total number of offset positions, the relative position of each of the offset positions, and/or the shape of the offset positions. Modifying the initial set of offset positions may involve using the motion vector data 212 to modify the selected characteristics of the offset positions and/or warping the initial set of offset positions. Determining 1208 the set of offset positions 408 in this way may be used where the set of offset positions 408 are defined independently of the search data 406 to which they are to be applied. Data representing the set of offset positions 408, for example, the size, shape, positions, and total number of offset positions may be stored in the processing system 1000, for example in the storage 1016. Determining 1208 the set of offset positions 408 may involve selecting or modifying data representing the set of offset positions. For example, the processing system 1000 may store offset position data that represents a plurality of candidate sets of offset positions, from which the set of offset positions 408 may be selected and/or modified.

Alternatively, or additionally, determining 1208 the set of offset positions 408 may comprise modifying the search data 406 based on the motion vector data 212. This may be the case where the set of offset positions 408 are defined with respect to the search data 406. In this example, and as described above with respect to FIG. 6, modifying the search data 406 may involve updating the search data 406, deriving the search data 406 from different portions of the second frame of image data 210, or warping the search data 406.

The execution engine 1010 determines 1210 search window data 520 representing the set of offset positions 408 applied to the search data 406 by, for each offset position, selecting a corresponding portion of the search data 406. The search window data 520 may include a tensor having a plurality of channels, wherein each channel of the tensor comprises a portion of the search data 406 selected based on a respective one of the set of offset positions 408 applied to the search data 406.

The search window data 520 and the template data 404 are provided to the motion engine 1014 and the motion engine 1014 determines 1212, for each offset position, a measure of similarity 414 between the template data 404 and the corresponding portion of search data 406. The motion engine 1014 then determines 1214 an optical flow vector 410 corresponding to the template data 404 by selecting an offset position of the set of offset positions 408 based on the measures of similarity 414 between the template data 404 and the corresponding portions of the search data 406. Once an offset position is selected, the optical flow vector data 410 may be determined by generating a vector indicating a spatial offset, or displacement, between the selected offset position and the template data 404.

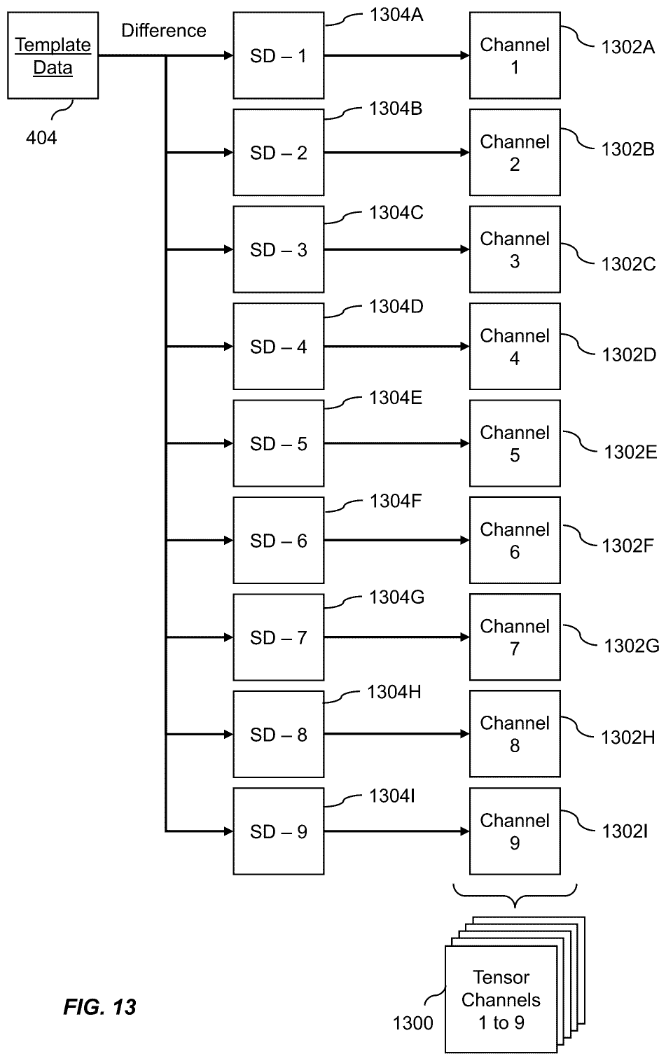

FIG. 13 shows an example of a tensor 1300 that may be generated by the motion engine 1014 when determining 1212 the measures of similarity 414. The tensor 1014 has a plurality of channels 1302A to 1302I which are generated by, for each of the plurality of channels 1302A to 1302I, determining difference values between the template data 404 and a portion of search window data 1304A to 1304I corresponding to an offset position of the set of offset positions 408. The difference values are then written into a channel of the tensor 1302a to 1302I.

Returning to FIG. 11, a convolution operation 1102 may then be performed on the tensor 1300 to obtain, for each channel of the tensor 1300, a respective measure of similarity between the template data 404 and the corresponding portion of the search data 1304A to 1304I. The convolution operation 1102 may involve a SAD calculation, SSD calculation, and/or other suitable operations for example, scaling.

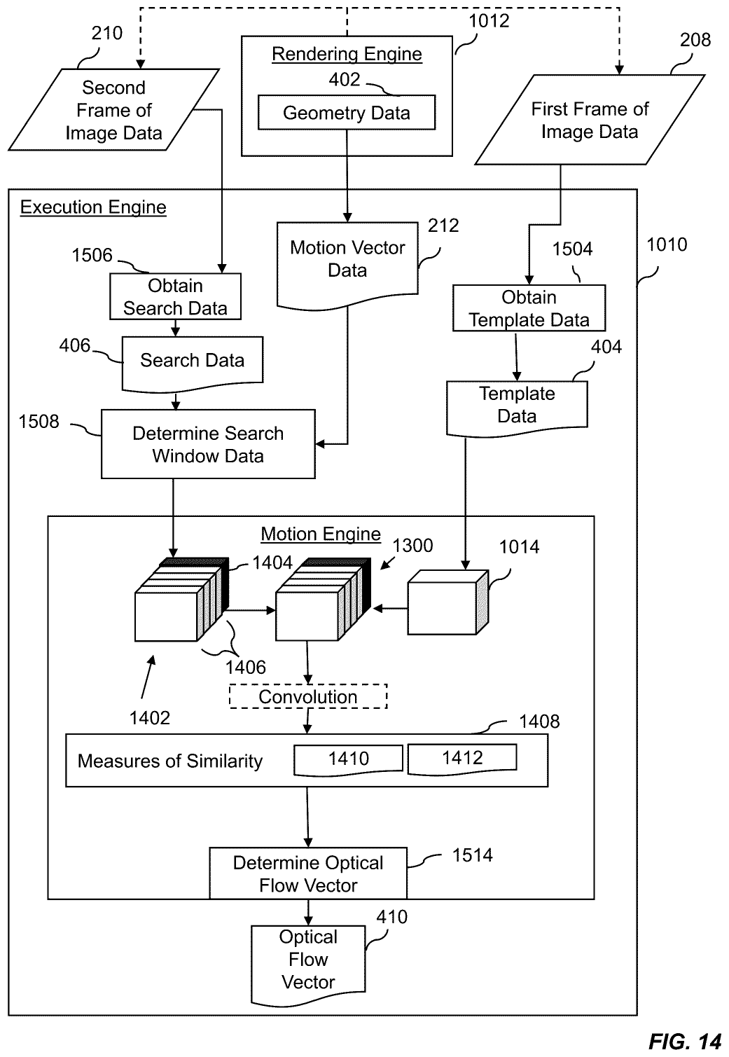

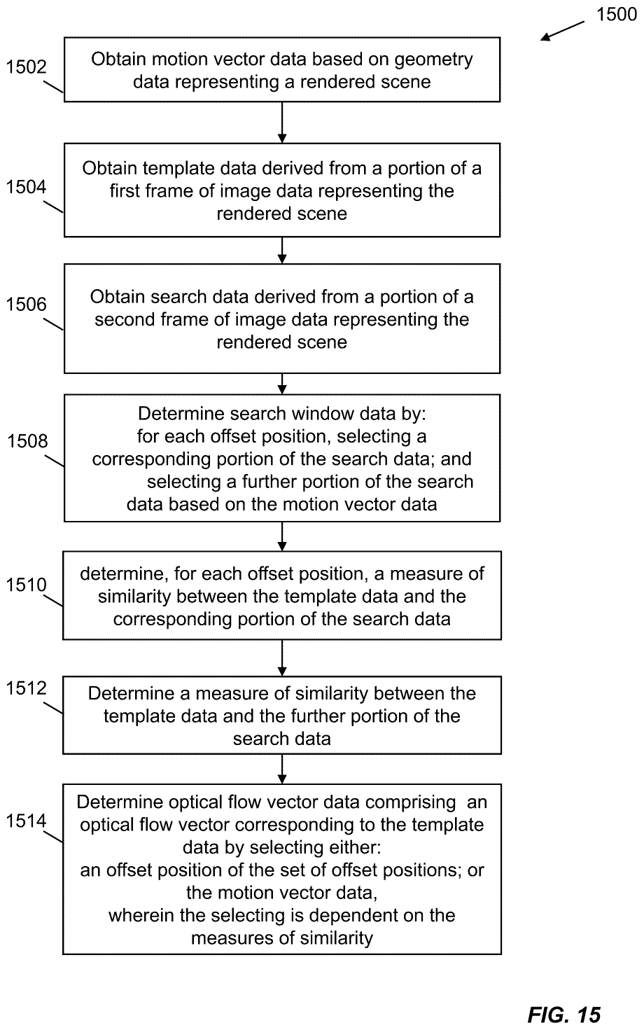

FIGS. 14 and 15 show a detailed example of how the processing system 1000 may be configured to perform a computer-implemented method 1500, shown in the flow chart of FIG. 15, for determining an optical flow vector data 410 that is similar to the examples described above with reference to FIG. 8. This method 1500 involves using the rendering engine 1012 to generate 1502 motion vector data 212 and using the execution engine 1010 to obtain 1504 template data 404, derived from the first frame of image data 208, and obtain 1506 search data 406 derived from the second frame of image data 210.

In this example, the process of determining 1508 the search window data 1402 is modified using the motion vector data 212. Specifically, in addition to applying the offset positions to the search data 406, the execution engine 1010 selects a further portion of search data 1404 based on the motion vector data 212. As described above with respect to FIG. 8, this may involve selecting an additional portion of the search data 406 that is different to the portions of the search data 1406 selected based on the set of offset positions 408. Alternatively, this may involve selecting a further portion of search data 1404 from the second frame of image data 210. The further portion of search data 1404 that is selected may be a portion of search data that is pointed to by the motion vector data 212.

The motion engine 1014 then determines 1510 and 1512 measures of similarity 1408, including determining 1510 a measure of similarity 1410 for each offset position 408, and determining 1512 a measure of similarity 1412 between the template data 404 and the further portion of the search data 1404. An optical flow vector data 410, corresponding to the template data 404, is then determined 1514 by selecting either an offset position of the set of offset positions 408 or the motion vector data 212. The selection of either an offset position of the set of offset position 408 or the motion vector data 212 is dependent on the measures of similarity 1410 and 1412 and may involve, for example, comparing the measures of similarity 1410 and 1412 to determine which portion of search data 406 is most similar to the template data 404.

Determining 1510 and 1512 the measures of similarity 1410 and 1412 may involve generating a tensor 1300, as discussed above with respect to FIG. 13. In some examples, one tensor may be determined for the portions of search data 1406 that correspond to the offset positions and the further portion of search data 1404. Alternatively, two tensors may be used. For example, a first tensor may be used to determine the measures of similarity 1410 for the portions of search data 1406 that correspond to the offset positions, and a second tensor may be used to determine a measure of similarity 1412 between the template data 404 and the further portion of search data 1404.

FIG. 16 shows an example of a method used by the rendering engine 1012 to generate motion vector data 212. While the examples described with respect to FIG. 16 refer to the rendering engine 1012, it is to be appreciated that these techniques for generating motion vector data may also be used in combination with the examples described above with respect to FIGS. 2 to 9, wherein the processing system 200 may be configured to generate the motion vector data 212.

In the example shown in FIG. 16, the rendering engine 1012 generates geometry data 402 associated with a rendered scene. The geometry data 402 includes depth data 1602, representing a relative depth of vertices in the rendered scene, and camera model data 1604 which is used to determine a projection of rendered vertices, or objects, onto image frames representing the rendered scene. The depth data 1602 may be stored in a depth buffer, and include an array of values representing a relative depth between a frame plane and the vertices in the rendered scene.

The camera model data 1604 may include a number of transform functions, or matrices, including a model matrix 1606, a view matrix 1608, and a projection matrix 1610. These matrices are used to transform coordinates in object space, for example representing the relative position of vertices within the rendered scene, to a frame space representing the position of those vertices in image frames representing the rendered scene that are generated by the rendering engine 1012.

To generate motion vector data 212 the rendering engine 1012 determines a first coordinate 1612, in object space, representing the position of a vertex in the rendered scene. The first coordinate 1612 may then be transformed 1614 using the camera model data 1604 and/or the depth data 1602. This may involve applying any one or more of the model matrix 1606, the view matrix 1608, the projection matrix 1610, to obtain a second coordinate 1616 representing the position of the vertex in the first frame of image data 208. The second coordinate 1616 represents the position of the vertex as projected onto the first frame of image data 208, which may be referred to as the frame plane. The depth data 1602 may be used to determine whether the vertex is actually visible in the first frame of image data 208. For example, where two vertices in the rendered scene are projected onto the same region in the frame plane in the first frame of image data 208 occlusion may occur. The depth data 1602 may be used to resolve which of these two vertices are actually present in the first frame of image data 208. Additional data such as translucence and/or luminance information may also be used to determine what vertices are represented in the first frame of image data 208 after projection from object space to the frame plane.

Motion vector data 212 for the vertex may be generated using the second coordinate 1616, depth data 1602, and a third coordinate 1618 representing a position of the vertex in the second frame of image data 210. The third coordinate 1618 may be generated by applying a similar process to obtain the position of the vertex in the second frame of image data 210 using camera model data 1604 and/or depth data 1602. Where the position of the vertex moves between the first frame of image data 208 and the second frame of image data 210, the second coordinate 1616 and the third coordinate 1618 will typically represent different positions. The motion vector data 212 may then be generated by determining a vector representing the difference between the position of the second coordinate 1616 in the first frame of image data 208 and the third coordinate 1618 in the second frame of image data 210.

The camera model data 1604 and depth data 1602 used to project a coordinate of the vertex onto the first frame of image data 208 may be different to the camera model data 1604 and depth data 1602 used to project a coordinate of the vertex onto the second frame of image data 210. For example, where the view of the rendered scene changes between the first frame of image data 208 and the second frame of image data 210, the camera model data 1604 and depth data 1602 may be updated to reflect the change in view. This may appear as a change in the relative position of a camera or observer in the rendered scene. The depth data 1602 and the camera model data 1604 may be updated to reflect a change in the position of the frame plane with respect to the rendered scene. The camera model data 1604 may also be updated to reflect any changes between the rotation, perspective, or focal length of the view represented in the first frame of image data 208 and the second frame of image data 210.

Transforming 1614 coordinates in object space to a frame plane may be performed for each vertex in the rendered scene. When generating the first frame of image data 208 and the second frame of image data 210 the rendering engine 1012 may be configured to transform 1614 coordinates in object space to coordinates in the frames of image data 208 and 210 when determining what data should be rendered in the frames of image data 208 and 210. This process may be applied regardless of whether these coordinates are used to generate motion vector data 212, and hence determining motion vector data 212 may be computationally cheap and require minimal additional processing. In some examples, the precision of the camera model data 1604 may be increased for regions of the frames of image data 208 and 210 which are likely to be relevant to the determination of motion vector data 212.

The projection of coordinates in object space to the frame plane may be at a precision such that coordinates in the object space are projected to single pixel locations in the frames of image data 208 and 210. In some cases, a coordinate in object space, when projected into the frame plane, may represent a region comprising a plurality of pixel locations. In some cases, the precision of the coordinates in object space may be increased such that the resulting coordinates in the frame plane relate to single pixel values. In other examples, motion vector data 212 determined using these processes may provide a block precision motion vector, wherein the motion vector data 212 represents motion vectors for blocks of pixel locations in the frames of image data 208 and 210.

The various examples described above may employed alone or in combination with any other examples described above. For example, the motion vector data 212 may be used to select or modify the search data or offset positions and additionally used to select a further portion of search data. As discussed above with respect to FIG. 1, block matching may be performed in a pyramidal structure wherein frames of image data are down-sampled and block matching is performed first at the lowest resolution and progressively refined as the frames of image data are upscaled. In this context, using the motion vector data 212 to determine, or modify, the search data 406 or the set of offset positions 408 may be used at the highest level of the pyramid (lowest resolution) such that the optical flow vector determined at the lowest resolution is more accurate. A subsequent level of the pyramid (representing progressively higher resolution) may then refine the optical flow vector generated at this lowest resolution. The use of motion vector data 212 at the lowest resolution increases the accuracy of the first optical flow vector and can thereby reduce the complexity of block matching in the subsequent levels. For example, the subsequent levels can be performed with reduced search window sizes and/or fewer offset positions, and maintain the same level of accuracy in the final optical flow vectors that are determined.

In subsequent levels of the pyramidal structure of block matching, the motion vector data 212 may be used to select additional candidate portions of search data to be compared with the template 404 when determining an optical flow vector.

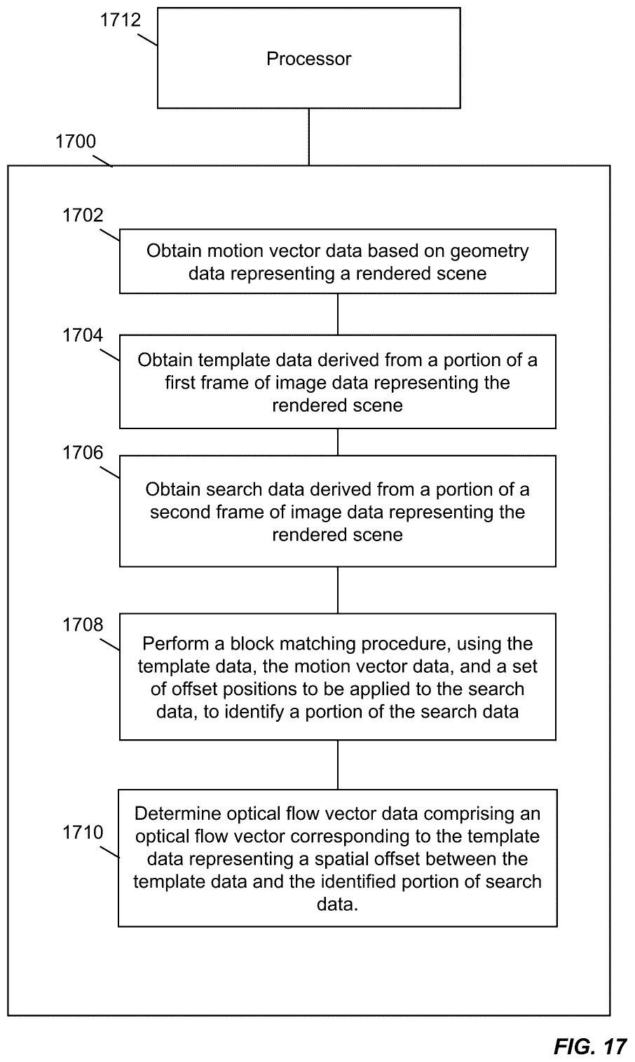

In some examples, a non-transitory storage medium may be provided that includes computer executable instructions for performing the methods described above. FIG. 17 shows an example of a non-transitory computer-readable storage medium 1700 comprising computer executable instructions 1702 to 1710 that, when executed by a processor 1712, cause the processor 1712 to perform the method 300 for determining an optical flow vector described above with respect to FIGS. 3 to 9.

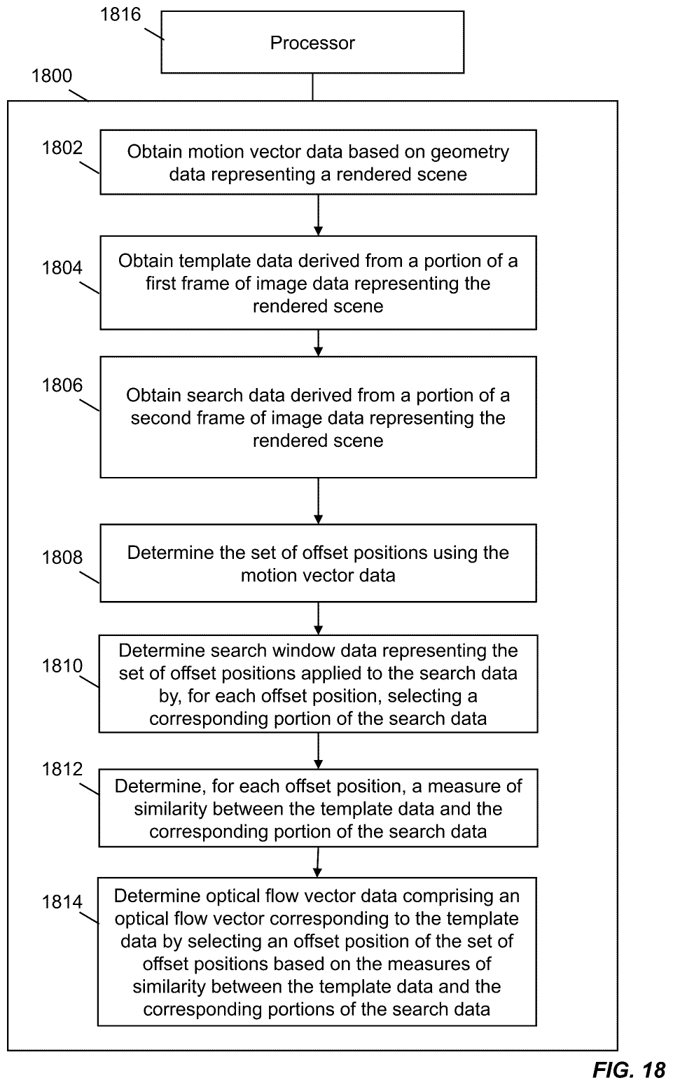

FIG. 18 shows an example of a non-transitory computer-readable storage medium 1800 comprising computer executable instructions 1802 to 1814 that, when executed by a processor 1816, cause the processor 1816 to perform the method 1200 for determining an optical flow vector described above with respect to FIGS. 11 and 12.

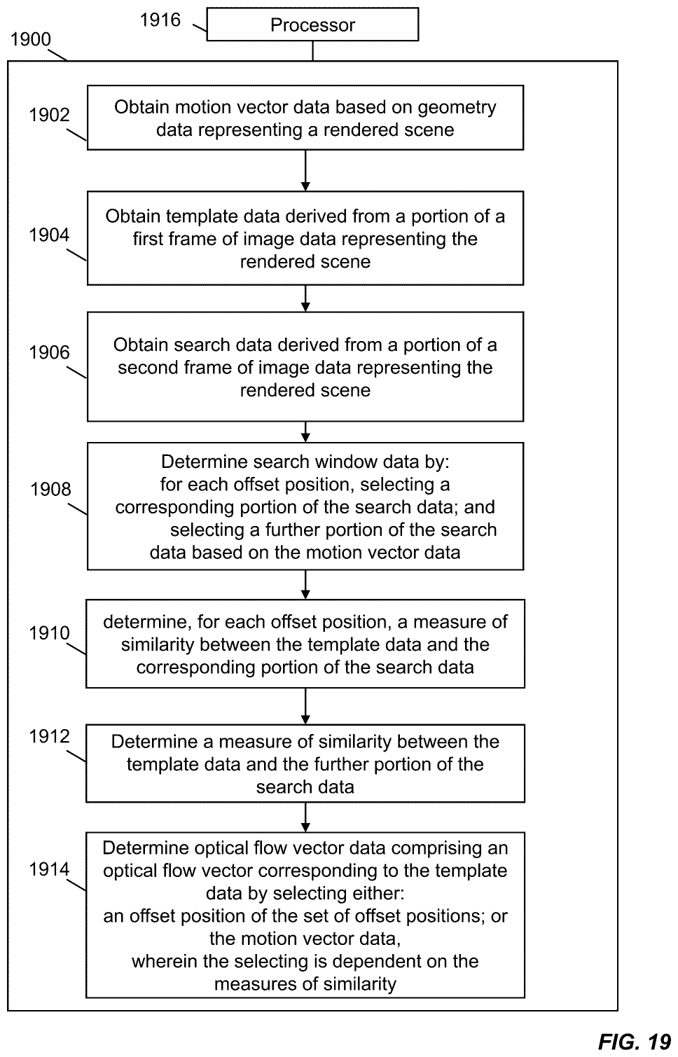

FIG. 19 shows an example of a non-transitory computer-readable storage medium 1900 comprising computer executable instructions 1902 to 1914 that, when executed by a processor 1916, cause the processor 1916 to perform the method 1500 for determining an optical flow vector described above with respect to FIGS. 14 and 15.

It is to be appreciated that the examples described above may be used in combination with any other additional techniques for determining motion vectors and/or processing image data. Additionally, various examples not described above are envisaged, for example, additional template data may be selected using the motion vector data 212. In this case, the motion vector data 212 may be used to select an additional portion of first frame of image data 208 which is then used in the block matching procedure to compare with portions of the search data to obtain an optical flow vector. It is also to be appreciated that further processing may be applied after the performance of the methods 300, 1200, and 1500. For example, the optical flow vector may be used to apply a temporal algorithm such as temporal anti-aliasing, framerate up-sampling, motion blur, and others.

As stated above, the examples described are provided with respect to a single channel of pixel values for the first frame of image data and the second frame of image data. Where the first and second frames of image data are represented using a plurality of channels, representing luma and/or chroma components, the methods may be employed by processing multiple channels simultaneously and/or in parallel.

### Numbered Clauses

Various aspects of the present disclosure are set out in the following numbered clauses.

1. A processing system for processing template data and search data according to a search window applied to the search data, the search window comprising a set of offset positions, the processing system comprising a rendering engine, an execution engine, and a motion engine,
the rendering engine being configured to generate motion vector data based on geometry data representing a rendered scene,
the execution engine being configured to:
   obtain template data derived from a portion of a first frame of image data representing the rendered scene;
   obtain search data derived from a portion of a second frame of image data representing the rendered scene;
   determine the set of offset positions using the motion vector data; and
   determine search window data representing the set of offset positions applied to the search data by, for each offset position, selecting a corresponding portion of the search data, and
the motion engine being configured to:
   determine, for each offset position, a measure of similarity between the template data and the corresponding portion of the search data; and
   determine optical flow vector data comprising an optical flow vector corresponding to the template data by selecting an offset position of the set of offset positions based on the measures of similarity between the template data and the corresponding portions of the search data.
      2. The processing system according to clause 1, wherein determining the set of offset positions comprises modifying the search data based on the motion vector data.
      3. The processing system according to clause 2, wherein modifying the search data comprises warping the search data using the motion vector data.
      4. The processing system according to clause 1, wherein determining the set of offset positions comprises:
identifying an initial set of offset positions; and
modifying the initial set of offset positions using the motion vector data to obtain the set of offset positions.
   5. The processing system of clause 1, wherein determining, for each offset position, a measure of similarity between the template data and the corresponding portion of the search data comprises:
determining a tensor having a plurality of channels by, for each of the plurality of channels, determining difference values between the template data and a portion of search window data corresponding to an offset position of the set of offset positions, and writing the difference values to a channel of the tensor; and
perform a convolutional operation on the tensor to obtain, for each channel of the tensor, a respective measure of similarity between the template data and the corresponding portion of the search data.
   6. The processing system according to clause 5, wherein the convolutional operation comprises, for each channel of the tensor, summing the associated difference values to obtain a respective measure of similarity between the template data and the corresponding offset position in the search data.
   7. The processing system according to clause 1, wherein determining optical flow vector data comprising an optical flow vector corresponding to the template data comprises generating a vector indicating a spatial displacement between the template data and the selected offset position.
   8. The processing system according to clause 1, wherein the geometry data representing the rendered scene comprises:
depth data representing a relative depth of vertices in the rendered scene; and
camera model data.
   9. The processing system according to clause 8, wherein the camera model data comprises any of:
a model matrix;
a view matrix; or
a projection matrix.
   10. The processing system according to clause 9, wherein generating the motion vector data comprises, for a given vertex in the rendered scene:
determining a first coordinate, in object space, representing a position of the vertex in the rendered scene;
transforming the first coordinate using the model matrix, the view matrix, and the projection matrix to obtain a second coordinate representing a position of the vertex in the first frame;
generating the motion vector data for the vertex using the second coordinate, the depth data, and a third coordinate representing a position of the vertex in the second frame.
   11. The processing system according to clause 1, wherein the template data and the search data each comprise a two-dimensional tensor.
   12. A computer-implemented method of determining optical flow vector data for a rendered scene using template data and search data, the method comprising:
generating motion vector data based on geometry data representing a rendered scene;
obtaining template data derived from a portion of a first frame of image data representing the rendered scene;
obtaining search data derived from a portion of a second frame of image data representing the rendered scene;
determining the set of offset positions using the motion vector data;
determining search window data representing the set of offset positions applied to the search data by, for each offset position, selecting a corresponding portion of the search data;
determining, for each offset position, a measure of similarity between the template data and the corresponding portion of the search data; and
determining optical flow vector data comprising an optical flow vector corresponding to the template data by selecting an offset position of the set of offset positions based on the measures of similarity between the template data and the corresponding portions of the search data.
   13. A non-transitory computer-readable storage medium comprising computer-executable instructions which, when executed by a processor, cause the processor to:
generate motion vector data based on geometry data representing a rendered scene;
obtain template data derived from a portion of a first frame of image data representing the rendered scene;
obtain search data derived from a portion of a second frame of image data representing the rendered scene;
determine the set of offset positions using the motion vector data;
determine search window data representing the set of offset positions applied to the search data by, for each offset position, selecting a corresponding portion of the search data;
determine, for each offset position, a measure of similarity between the template data and the corresponding portion of the search data; and
determine optical flow vector data comprising an optical flow vector corresponding to the template data by selecting an offset position of the set of offset positions based on the measures of similarity between the template data and the corresponding portions of the search data.
   14. A processing system for processing template data and search data according to a search window applied to the search data, the search window comprising a set of offset positions, the processing system comprising, a rendering engine, an execution engine, and a motion engine,
the rendering engine being configured to generate motion vector data based on geometry data representing a rendered scene,
the execution engine being configured to:
   obtain template data derived from a portion of a first frame of image data representing the rendered scene;
   obtain search data derived from a portion of a second frame of image data representing the rendered scene; and
   determine search window data by:
      for each offset position, selecting a corresponding portion of the search data; and
      selecting a further portion of search data based on the motion vector data, and
the motion engine being configured to:
   determine, for each offset position, a measure of similarity between the template data and the corresponding portion of the search data;
   determine a measure of similarity between the template data and the further portion of search data; and
   determine optical flow vector data comprising an optical flow vector corresponding to the template data by selecting either:
      an offset position of the set of offset positions; or
      the motion vector data,
      wherein the selecting is dependent on the measures of similarity.
         15. The processing system of clause 14, wherein determining, for each offset position, a measure of similarity between the template data and the corresponding portion of the search data comprises:
determining a first tensor having a plurality of channels by, for each of the plurality of channels, determining difference values between the template data and a portion of search window data corresponding to an offset position of the set of offset positions, and writing the difference values to a channel of the first tensor; and
perform a convolutional operation on the first tensor to obtain, for each channel of the tensor, a respective measure of similarity between the template data and the corresponding portion of search data.
   16. The processing system according to clause 14, wherein determining a measure of similarity between the template data and the further portion of the search data comprises:
determining a second tensor having at least one channel by determining difference values between the template data and the further portion of search data, and writing the difference values to a channel in the second tensor; and
perform a convolutional operation on the second tensor to obtain a measure of similarity between the template data and the further portion of search data.
   17. The processing system according to clause 16, wherein the convolution operation comprises, for each channel of the first tensor, summing the associated difference values to obtain an indication of a total difference between the template data and the corresponding portion of the search data.
   18. The processing system according to clause 14, wherein selecting either an offset position of the set of offset positions or the motion vector data comprises comparing the measures of similarity.
   19. A computer-implemented method of determining optical flow vector data for a rendered scene using template data and search data, the method comprising:
generating motion vector data based on geometry data representing a rendered scene,
obtaining template data derived from a portion of a first frame of image data representing the rendered scene;
obtaining search data derived from a portion of a second frame of image data representing the rendered scene;
determining search window data by:
   for each offset position, selecting a corresponding portion of the search data; and
   selecting a further portion of search data based on the motion vector data;
determining, for each offset position, a measure of similarity between the template data and the corresponding portion of the search data;
determining a measure of similarity between the template data and the further portion of search data; and
determining optical flow vector data comprising an optical flow vector corresponding to the template data by selecting either:
   an offset position of the set of offset positions; or
   the motion vector data,
   wherein the selecting is dependent on the measures of similarity.
      20. A non-transitory computer-readable storage medium comprising computer-executable instructions which, when executed by a processor, cause the processor to:
generate motion vector data based on geometry data representing a rendered scene,
obtain template data derived from a portion of a first frame of image data representing the rendered scene;
obtain search data derived from a portion of a second frame of image data representing the rendered scene;
determine search window data by:
   for each offset position, selecting a corresponding portion of the search data; and
   selecting a further portion of search data based on the motion vector data;
determine, for each offset position, a measure of similarity between the template data and the corresponding portion of the search data;
determine a measure of similarity between the template data and the further portion of search data; and
determine optical flow vector data comprising an optical flow vector corresponding to the template data by selecting either:
   an offset position of the set of offset positions; or
   the motion vector data,
   wherein the selecting is dependent on the measures of similarity.

What is claimed is:

1. A processing system configured to determine optical flow vector data for a rendered scene using template data and search data, the processing system comprising circuitry configured to cause the processing system to:
obtain motion vector data based on geometry data representing the rendered scene;
obtain template data derived from a portion of a first frame of image data representing the rendered scene;
obtain search data derived from a portion of a second frame of image data representing the rendered scene;
perform a block matching procedure, using the template data, the motion vector data, and a set of offset positions to be applied to the search data, to identify a portion of the search data; and
determine optical flow vector data comprising an optical flow vector corresponding to the template data representing a spatial offset between the template data and the identified portion of search data.

2. The processing system of claim 1, wherein performing the block matching procedure comprises:
modifying the search data according to the motion vector data;
determining search window data by, for each offset position, selecting a corresponding portion of the modified search data;
determining, for each offset position, a measure of similarity between the template data and a corresponding portion of the search window data; and
selecting an offset position based on the measures of similarity,
wherein the identified portion of search data comprises search data corresponding to the selected offset position.

3. The processing system of claim 2, wherein modifying the search data comprises warping the search data based on the motion vector data.

4. The processing system of claim 1, wherein performing the block matching procedure comprises:
modifying the set of offset positions according to the motion vector data;
determining search window data by, for each offset position in the set of modified offset positions, selecting a corresponding portion of the search data;
determining, for each offset position, a measure of similarity between the template data and a corresponding portion of the search window data; and
selecting an offset position based on the measures of similarity,
wherein the identified portion of search data comprises search data corresponding to the selected offset position.

5. The processing system of claim 4, wherein modifying the set of offset positions comprises warping the set of offset positions.

6. The processing system of claim 4, wherein modifying the set of offset positions comprises any one or more of:
adding an additional offset position to the set of offset positions;
removing an offset position from the set of offset positions; or
applying a spatial bias to one or more offset positions in the set of offset positions.

7. The processing system of claim 1, wherein performing the block matching procedure comprises:
determining search window data by:
for each offset position, selecting a corresponding portion of the search data; and
selecting a further portion of search data using the motion vector data;
determining a set of similarity measures indicative of a difference between the template data and a respective portion of the search window data, the set of similarity measures comprising:
a first subset of similarity measures indicative of a difference between the template data and a corresponding portion of the search data for each of the offset positions; and
a second subset of similarity measures indicative of a difference between the template data and the further portion of the search data selected using the motion vector data;
identifying the portion of search data by selecting either an offset position or the motion vector data based on the set of similarity measures.

8. The processing system according to claim 1, wherein the geometry data representing the rendered scene comprises:
depth data representing a relative depth of vertices in the rendered scene; and
camera model data, wherein the camera model data comprises any of:
a model matrix;
a view matrix; or
a projection matrix.

9. The processing system according to claim 8, wherein generating the motion vector data comprises, for a given vertex in the rendered scene:
determining a first coordinate, in object space, representing a position of the vertex in the rendered scene;
transforming the first coordinate using the model matrix, the view matrix, and the projection matrix to obtain a second coordinate representing a position of the vertex in the first frame;
generating the motion vector data for the vertex using the second coordinate, the depth data, and a third coordinate representing a position of the vertex in the second frame.

10. The processing system of claim 1, wherein the processing system comprises a rendering engine, an execution engine, and a motion engine,
wherein the obtaining the motion vector data comprises using the rendering engine to generate the motion vector data based on the geometry data,
wherein the execution engine is configured to obtain the template data and obtain the search data,
wherein performing the block matching procedure comprises:
using the execution engine to:
determine the set of offset positions using the motion vector data; and
determine search window data representing the set of offset positions applied to the search data by, for each offset position, selecting a corresponding portion of the search data; and
using the motion engine to determine, for each offset position, a measure of similarity between the template data and the corresponding portion of the search data, and
wherein determining the optical flow vector data comprises using the motion engine to select an offset position of the set of offset positions based on the measures of similarity between the template data and the corresponding portions of the search data.

11. The processing system according to claim 10, wherein determining the set of offset positions comprises modifying the search data based on the motion vector data.

12. The processing system according to claim 10, wherein determining the set of offset positions comprises:
identifying an initial set of offset positions; and
modifying the initial set of offset positions using the motion vector data to obtain the set of offset positions.

13. The processing system according to claim 10, wherein determining optical flow vector data comprising an optical flow vector corresponding to the template data comprises generating a vector indicating a spatial displacement between the template data and the selected offset position.

14. The processing system of claim 10, wherein determining, for each offset position, a measure of similarity between the template data and the corresponding portion of the search data comprises:
determining a tensor having a plurality of channels by, for each of the plurality of channels, determining difference values between the template data and a portion of search window data corresponding to an offset position of the set of offset positions, and writing the difference values to a channel of the tensor; and
perform a convolutional operation on the tensor to obtain, for each channel of the tensor, a respective measure of similarity between the template data and the corresponding portion of the search data.

15. The processing system according to claim 14, wherein the convolutional operation comprises, for each channel of the tensor, summing the associated difference values to obtain a respective measure of similarity between the template data and the corresponding offset position in the search data.

16. The processing system of claim 1, wherein the processing system comprises, a rendering engine, an execution engine, and a motion engine,
wherein obtaining the motion vector data comprises using the rendering engine to generate the motion vector data based on the geometry data,
wherein the execution engine is configured to obtain the template data and obtain the search data,
wherein performing the block matching procedure comprises:
using the execution engine to determine search window data by:
for each offset position, selecting a corresponding portion of the search data; and
selecting a further portion of search data based on the motion vector data; and
using the motion engine to:
determine, for each offset position, a measure of similarity between the template data and the corresponding portion of the search data; and
determine a measure of similarity between the template data and the further portion of search data,
wherein determining the optical flow vector data comprises using the motion engine to select either:
an offset position of the set of offset positions; or
the motion vector data,
wherein the selecting is dependent on the measures of similarity.

17. The processing system of claim 16, wherein determining, for each offset position, a measure of similarity between the template data and the corresponding portion of the search data comprises:
determining a first tensor having a plurality of channels by, for each of the plurality of channels, determining difference values between the template data and a portion of search window data corresponding to an offset position of the set of offset positions, and writing the difference values to a channel of the first tensor; and
perform a convolutional operation on the first tensor to obtain, for each channel of the tensor, a respective measure of similarity between the template data and the corresponding portion of search data,
wherein selecting either an offset position of the set of offset positions or the motion vector data comprises comparing the measures of similarity.

18. The processing system according to claim 16, wherein determining a measure of similarity between the template data and the further portion of the search data comprises:
determining a second tensor having at least one channel by determining difference values between the template data and the further portion of search data, and writing the difference values to a channel in the second tensor; and
perform a convolutional operation on the second tensor to obtain a measure of similarity between the template data and the further portion of search data.

19. A computer implemented method of determining optical flow vector data for a rendered scene using template data and search data, the method comprising:
obtaining motion vector data based on geometry data representing the rendered scene;
obtaining template data derived from a portion of a first frame of image data representing the rendered scene;
obtaining search data derived from a portion of a second frame of image data representing the rendered scene;
performing a block matching procedure, using the template data, the motion vector data, and a set of offset positions to be applied to the search data, to identify a portion of the search data; and
determining optical flow vector data comprising an optical flow vector corresponding to the template data representing a spatial offset between the template data and the identified portion of the search data.

20. A non-transitory computer-readable storage medium comprising computer-executable instructions which, when executed by a processor, cause the processor to:
obtain motion vector data based on geometry data representing the rendered scene;
obtain template data derived from a portion of a first frame of image data representing the rendered scene;
obtain search data derived from a portion of a second frame of image data representing the rendered scene;
perform a block matching procedure, using the template data, the motion vector data, and a set of offset positions to be applied to the search data, to identify a portion of the search data; and
determine optical flow vector data comprising an optical flow vector corresponding to the template data representing a spatial offset between the template data and the identified portion of search data.
